(19) United States
(12) Patent Application Publication
(10) Pub. No.: US 2026/0062340 A1
(43) Pub. Date: Mar. 5, 2026

(54) FRONT-LOADED STRESS PROFILES FOR HIGH-STRESS APPLICATIONS

(71) Applicant: CORNING INCORPORATED, Corning, NY (US)

(72) Inventors: Venkatesh BOTU, Corning, NY (US); Timothy Michael GROSS, Painted Post, NY (US); Qiao LI, Horseheads, NY (US); Rostislav Vatchev ROUSSEV, Painted Post, NY (US); Ljerka UKRAINCZYK, Ithaca, NY (US)

(21) Appl. No.: 19/311,122

(22) Filed: Aug. 27, 2025

Related U.S. Application Data
(60) Provisional application No. 63/689,377, filed on Aug. 30, 2024.
(60) Provisional application No. 63/697,079, filed on Sep. 20, 2024.

(51) Int. Cl. C03C 3/091; C03C 3/083; C03C 4/00

(52) U.S. Cl. CPC C03C 3/091; C03C 3/083; C03C 4/00; C03C 2201/32; C03C 2201/50

(57) ABSTRACT

Glass articles having high surface compressive stress (CS) and high CS-integrated area are provided. Methods of making such articles include chemical ion exchange processes.

### CROSS-REFERENCE TO RELATED APPLICATIONS

This application claims the benefit of priority under 35 U.S.C. § 119 of U.S. Provisional Application Ser. No. 63/697,079 filed on Sep. 20, 2024 and U.S. Provisional Application Ser. No. 63/689,377 filed on Aug. 30, 2024, the contents of each of which are relied upon and incorporated herein by reference in their entireties.

### FIELD

This disclosure relates to glass articles having high surface compressive stress (CS) and high CS-integrated area, as well as to chemical ion exchange processes to prepare such glass articles.

### TECHNICAL BACKGROUND

Designs of devices in the consumer electronics market continue to evolve. Designs that include 2.5D and 3D configurations are becoming more common as these features improve aesthetics of the devices. Handheld devices such as phones and tablets, and heavier consumer electronic devices such as headsets, other applications such as automotive interior displays, complex devices such as bendable phones, having 2.5D or 3D cover glasses are prone to impact events, which can introduce flaws. Impact events are a common cause of failure for the cover glass. To combat this failure mode, typically compressive stresses are added to a surface of the cover glass to help resist damage and failure. Depth of damage is related to depth of compressive stress with respect to survivability in these events.

Chemical treatment is a strengthening method to impart a desired and/or engineered stress profile in a glass article, such as a cover glass, the stress profile having one or more of the following parameters: compressive stress (CS), depth of compression (DOC), and maximum central tension (CT). Many glass articles, including those with engineered stress profiles, have a compressive stress that is highest or at a peak at the glass surface and reduces from a peak value moving away from the surface into the depth of the article, and there is zero stress at some interior location of the glass article before the stress in the glass article becomes tensile. Chemical strengthening by ion exchange (IOX) of alkali-containing glass is a proven methodology in this field.

It has been a continuous effort for glass makers and handheld and consumer device manufacturers to improve protection of glass-containing devices from strong impacts.

### SUMMARY

Aspects of the disclosure pertain to glass articles having various configurations including traditional 2D (planar), 2.5D, and 3D, and methods of making the same. Traditional 2D configurations are those glasses considered totally flat with no edge or a 90 degree edge. Reference to 2.5D configurations herein means those glasses having curvature, usually considered slight curvature, at the edges. As to 3D configurations, those glasses have curvature, usually significant, at any location. Such glass articles are used, for example, in consumer devices and automotive interiors.

In an aspect, a glass article comprises: opposing first and second surfaces defining a body of the article having a thickness (t); a stress profile of the body comprising: a spike region extending from the first surface to a knee located at a depth of layer (DOL); a peak compressive stress (CSₘₐₓ) of the spike region being greater than or equal to 1150 MPa; a tail region extending from the knee to a center of the glass article having a central tension (CT) and including a depth of compression (DOC); a compressive stress integral at a depth of 5 micrometers that is greater than or equal to 4.75 MPa·millimeter; and the compressive stress integral at a depth of 8 micrometers that is greater than or equal to 6.7 MPa·millimeter.

In an aspect, a glass article comprises: opposing first and second surfaces defining a body of the article having a thickness (t) of greater than or equal to 0.70 millimeters to less than or equal to 1.3 millimeters; a stress profile of the body comprising: a spike region extending from the first surface to a knee located at a depth of layer (DOL); a peak compressive stress (CSₘₐₓ) of the spike region being greater than or equal to 1000 MPa; a tail region extending from the knee to a center of the glass article having a central tension (CT) and including a depth of compression (DOC); and a compressive stress integral at a depth of 5 micrometers that is greater than or equal to 4.75 MPa·millimeter and the compressive stress integral at a depth of 8 micrometers that is greater than or equal to 7.0 MPa·millimeter.

In an aspect, a consumer electronic product comprises: a housing having a front surface, a back surface, and side surfaces; electrical components provided at least partially within the housing, the electrical components including at least a controller, a memory, and a display, the display being provided at or adjacent the front surface of the housing; and the glass article of any aspect herein disposed over the display.

In an aspect, a method of making a glass article comprising opposing first and second surfaces defining a body of the article having a thickness (t), and a stress profile of the body, the method comprises: conducting a primary ion exchange treatment including a primary ion exchange bath that comprises greater than or equal to 90% by weight of potassium nitrate to achieve a stress profile of the body comprising: a spike region extending from the first surface to a knee located at a depth of layer (DOL); a peak compressive stress (CSₘₐₓ) of the spike region being greater than or equal to 1150 MPa; a tail region extending from the knee to a center of the glass article having a central tension (CT) and including a depth of compression (DOC); a compressive stress integral at a depth of 5 micrometers that is greater than or equal to 4.75 MPa·millimeter; and the compressive stress integral at a depth of 8 micrometers that is greater than or equal to 6.7 MPa·millimeter.

Additional features and advantages will be set forth in the detailed description which follows, and in part will be readily apparent to those skilled in the art from that description or recognized by practicing the implementations described herein, including the detailed description which follows, the claims, as well as the appended drawings.

It is to be understood that both the foregoing general description and the following detailed description describe various implementations and are intended to provide an overview or framework for understanding the nature and character of the claimed subject matter. The accompanying drawings are included to provide a further understanding of the various implementations, and are incorporated into and constitute a part of this specification. The drawings illustrate the various implementations described herein, and together with the description serve to explain the principles and operations of the claimed subject matter.

### BRIEF DESCRIPTION OF THE DRAWINGS

The accompanying figures, which are incorporated in and constitute a part of this specification, illustrate several implementations described below.

FIG. 1 schematically depicts a cross-section of a glass having compressive stress layers on surfaces thereof according to implementations disclosed and described herein;

FIG. 2A is a plan view of an exemplary electronic device incorporating any of the glass articles disclosed herein;

FIG. 2B is a perspective view of the exemplary electronic device of FIG. 2A;

FIG. 3 is an exemplary stress profile across a thickness of a chemically strengthened glass article;

FIG. 4 is another exemplary stress profile across a thickness of a chemically strengthened glass article;

FIG. 5 is a schematic representation of a specimen geometry utilized to determine fracture toughness K_{IC} and a cross-section thereof;

FIG. 6 is a graph of compressive stress (MPa) versus thickness (microns) for Examples 1.1 to 1.2;

FIGS. 7-8 are graphs of compressive stress integral [A(z)] (MPa·millimeter) versus thickness (microns) for Examples 1.1 to 1.2 based on data of FIG. 6;

FIG. 9 is a graph of compressive stress (MPa) versus thickness (microns) for Examples 2 to 4;

FIG. 10 are graphs of compressive stress integral [A(z)] (MPa·millimeter) versus thickness (microns) for Example 1.2 based on the data of FIG. 6, Examples 2 to 4 based on the data of FIG. 9, and Comparative Examples A-C;

FIG. 11 is a graph of compressive stress (MPa) versus thickness (microns) for Examples 5 to 7;

FIG. 12 is a graph of compressive stress integral [A(z)] (MPa·millimeter) versus thickness (microns) for Examples 5 to 7 based on data of FIG. 11;

FIG. 13 is a graph of compressive stress (MPa) versus thickness (microns) for Examples 8 to 10; and

FIG. 14 is a graph of compressive stress integral [A(z)] (MPa·millimeter) versus thickness (microns) for Examples 8 to 10 based on data of FIG. 13.

### DETAILED DESCRIPTION

Before describing several exemplary implementations, it is to be understood that the disclosure is not limited to the details of construction or process steps set forth in the following disclosure. The disclosure provided herein is capable of other implementations and of being practiced or being carried out in various ways.

Reference throughout this specification to “one implementation,” “certain implementations,” “various implementations,” “one or more implementations” or “an implementation” means that a particular feature, structure, material, or characteristic described in connection with the implementation is included in at least one implementation of the disclosure. Thus, the appearances of the phrases such as “in one or more implementations,” “in certain implementations,” “in various implementations,” “in one implementation” or “in an implementation” in various places throughout this specification are not necessarily referring to the same implementation, or to only one implementation. Furthermore, the particular features, structures, materials, or characteristics may be combined in any suitable manner in one or more implementations.

### Definitions and Measurement Techniques

The terms “glass article” and “glass substrates” are used to include any object made of glass. Glass substrates according to one or more implementations can be selected from soda-lime silicate glass, alkali-alumino silicate glass, alkali-containing borosilicate glass, alkali-containing aluminoborosilicate glass, and alkali-containing phosphate glass.

A “base composition” is a chemical make-up of a substrate prior to any ion exchange (IOX) treatment. That is, the base composition is undoped by any ions from IOX. A composition at the center of a glass article that has been IOX treated is typically the same as the base composition when IOX treatment conditions are such that ions supplied for IOX do not diffuse into the center of the substrate. In one or more implementations, a central composition at the center of the glass article comprises the base composition.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass article that is “substantially free of MgO” is one in which MgO is not actively added or batched into the glass article, but may be present in very small amounts as a contaminant. As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two implementations: one modified by “about,” and one not modified by “about.” It will be further understood that the endpoints of each of the ranges are significant both in relation to the other endpoint, and independently of the other endpoint.

Unless otherwise specified, all compositions described herein are expressed in terms of mole percent (mol %) on an oxide basis.

A “stress profile” is stress as a function of thickness across a glass article. A compressive stress region extends from a first surface to a depth of compression (DOC) of the article, and is a region where the article is under compressive stress. A central tension region extends from the DOC to include the region where the article is under tensile stress.

As used herein, depth of compression (DOC) refers to the depth at which the stress within the glass article changes from compressive to tensile stress. At the DOC, the stress crosses from a positive (compressive) stress to a negative (tensile) stress and thus exhibits a stress value of zero. According to the convention normally used in mechanical arts, compression is expressed as a negative (<0) stress and tension is expressed as a positive (>0) stress. Throughout this description, however, positive values of stress are compressive stress (CS), which are expressed as a positive or absolute value—i.e., as recited herein, CS=|CS|. Additionally, negative values of stress are tensile stress. But when used with the term “tensile”, stress or central tension (CT) may be expressed as a positive value, i.e., CT=|CT|. Central tension (CT) refers to tensile stress in a central region or a central tension region of the glass article. Maximum central tension (maximum CT or CTₘₐₓ) may occur in the central tension region nominally at 0.5·t, where t is the article thickness, which allows for variation from exact center of the location of the maximum tensile stress. Peak tension (PT) refers to maximum tension measured, which may or may not be at the center of the article.

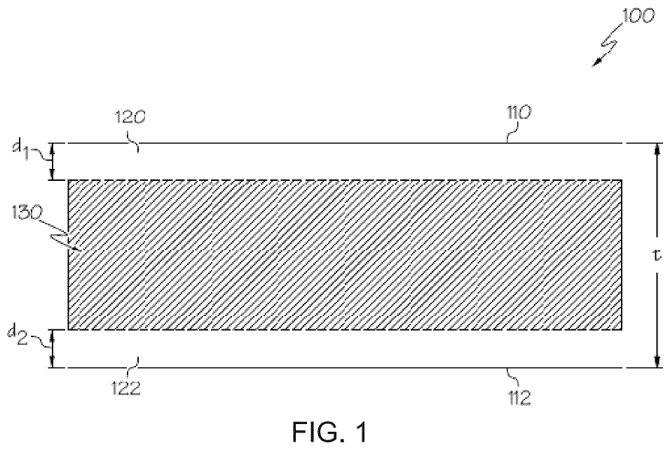

With reference to FIG. 1, a glass, which includes a glass article, has a thickness t and a first region under compressive stress (e.g., first and second compressive stress layers 120, 122 in FIG. 1) extending from the surface to a depth of compression (DOC) of the glass and a second region (e.g., central region 130 in FIG. 1) under a tensile stress or central tension (CT) extending from the DOC into the central or interior region of the glass.

The compressive stress (CS) has a maximum or peak value, which typically occurs at the surface of the glass (but such need not be the case as the peak may occur at a depth from the surface of the glass), and the CS varies with distance d from the surface according to a function. Referring again to FIG. 1, the first compressive stress layer 120 extends from first surface 110 to a depth d₁ and the second compressive stress layer 122 extends from second surface 112 to a depth d₂. Together, these segments define a compression region or CS of glass 100.

The compressive stress of both compressive stress layers (120, 122 in FIG. 1) is balanced by stored tension in the central region (130) of the glass.

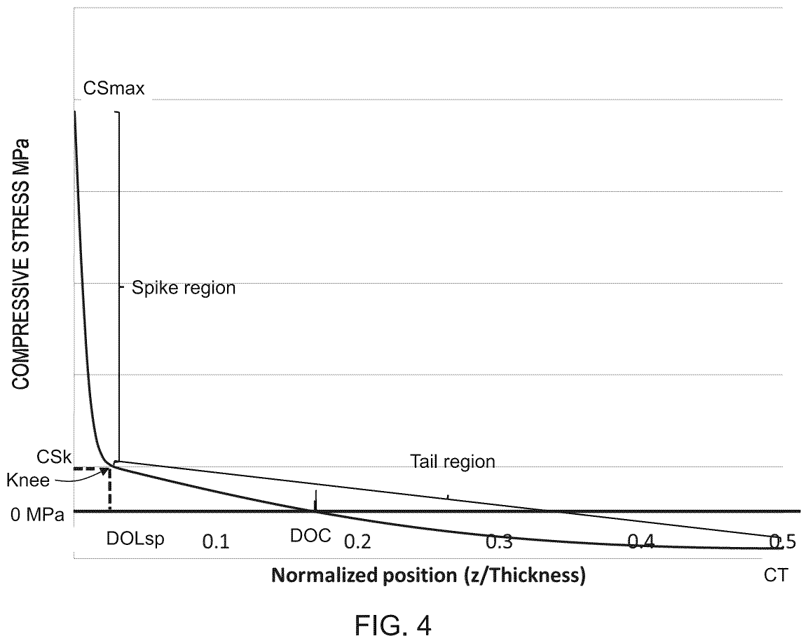

An exemplary stress profile of a chemically strengthened glass article is illustrated graphically in FIG. 3, across a thickness t defined by a first surface 302 and a second surface 304 opposing the first surface of a glass article 300 of one or more implementations. In one or more implementations, the thickness t may be about 3 millimeters or less, including all values and subranges therebetween.

The stress profile extends from the first surface 302 to the second surface 304 (or along the entire length of the thickness t). In the implementation shown in FIG. 3, the stress profile 312 as measured by SCALP as described herein is illustrated. The y-axis represents the stress value and the x-axis represents the thickness or depth within the glass article. The exemplary stress profile 312 includes a surface CS 310, a maximum CT 320, and a first DOC 330. The stress profile 312 has a CS layer 317 extending from a surface 302 to the first DOC 330. A second CS layer 317 extends from surface 304 to a second DOC 332. The stress profile 312 also has a CT layer 327 extending between the first DOC 330 and the second DOC 332.

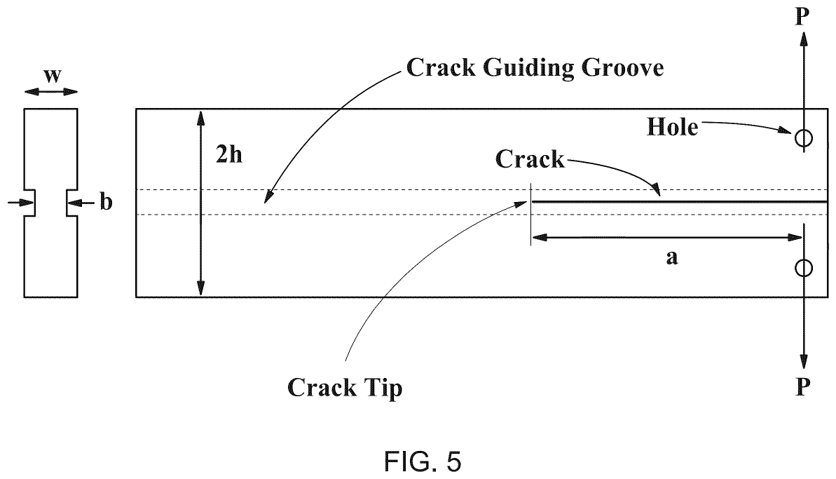

A “knee” of a stress profile is a depth of an article where the slope of the stress profile transitions from steep to gradual. See FIG. 4, for example. The knee may refer to a transition area over a span of depths where the slope is changing. The knee stress CSₖ is defined as the value of compressive stress that the deeper portion of the CS profile extrapolates to at the depth of spike (DOLₛₚ). The DOLₛₚ is reported as measured by a surface-stress meter by known methods. FIG. 4 shows generally a stress profile of compressive stress versus normalized position showing a spike region, a knee, and a tail region; CSmax, CSₖ, DOLₛₚ, and DOC.

A non-zero metal oxide concentration that varies from the first surface to a depth of layer (DOL) with respect to the metal oxide or that varies along at least a substantial portion of the article thickness (t) indicates that a stress has been generated in the article as a result of ion exchange. The variation in metal oxide concentration may be referred to herein as a metal oxide concentration gradient. The metal oxide that is non-zero in concentration and varies from the first surface to a DOL or along a portion of the thickness may be described as generating a stress in the glass article. The concentration gradient or variation of metal oxides is created by chemically strengthening a glass substrate in which a plurality of first metal ions in the glass substrate is exchanged with a plurality of second metal ions.

As used herein, the terms “depth of exchange”, “depth of layer” (DOL), “chemical depth of layer”, and “depth of chemical layer” may be used interchangeably, describing in general the depth at which ion exchange facilitated by an ion exchange process (IOX) takes place for a particular ion. DOL refers to the depth within a glass article (i.e., the distance from a surface of the glass article to its interior region) at which an ion of a metal oxide or alkali metal oxide (e.g., the metal ion or alkali metal ion) diffuses into the glass article where the concentration of the ion reaches a minimum value, as determined by Glow Discharge—Optical Emission Spectroscopy (GD-OES)). In some implementations, the DOL is given as the depth of exchange of the slowest-diffusing or largest ion introduced by an ion exchange (IOX) process. DOL with respect to potassium (DOL_{K}) is the depth at which the potassium content of the glass article reaches the potassium content of the underlying substrate. DOL with respect to sodium (DOL_{Na}) is the depth at which the sodium content of the glass article reaches the sodium content of the underlying substrate.

Unless otherwise specified, CT and CS are expressed herein in megaPascals (MPa), thickness is express in millimeters and DOC and DOL are expressed in microns (micrometers).

Compressive stress (including surface/peak CS, CSₘₐₓ) are measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. For the examples herein, surface/peak stress (CS) was measured based on a surface-stress meter FSM-6000 with measurement wavelength of 598 nm.

The maximum central tension (CT) or peak tension (PT) and stress retention values are measured using a scattered light polariscope (SCALP) technique known in the art. The Refracted near-field (RNF) method or SCALP may be used to measure the stress profile and the depth of compression (DOC). When the RNF method is utilized to measure the stress profile, the maximum CT value provided by SCALP is utilized in the RNF method. In particular, the stress profile measured by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass article adjacent to a reference block, generating a polarization-switched light beam that is switched between orthogonal polarizations at a rate of from 1 Hz to 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

Under some circumstances, stress profiles are obtained by use of inverse-WKB (IWKB), using a smooth IWKB method by Chiang 1985 (Kin Seng Chiang, “Construction of refractive-index profiles of planar dielectric waveguides from the distribution of refractive indexes”, Journal of Lightwave Technology, vol. LT-3, No.2, p. 385 (1985)). A choice to proceed according to IWKB-smooth can be made after observing that spacing between the first and second lowest-order modes was about the same and not exceeding the spacing between the second and third lowest-order modes. When this is the case, it is more appropriate to use an IWKB routine (e.g., IWKB-smooth) that is designed for profiles having no surface slope. The index profiles for TM and TE polarization were obtained using this procedure, the birefringence profile was then obtained as the difference of the TM and TE index profile. Finally, the stress profiles were obtained by dividing the birefringence profile by the stress-optic coefficient.

Under some circumstances, stress profiles are obtained by use of an inverse-WKB (IWKB) method, using a stepwise linear IWKB method according to U.S. Pat. No. 9,140,543, which is incorporated herein by reference in its entirety. A choice to proceed according to IWKB-stepwise linear can be made after observing that spacing between the first and second lowest-order modes exceeded the spacing between the second and third lowest-order modes. When this is the case, it is more appropriate to use an IWKB routine (e.g., IWKB-stepwise linear) that is designed for profiles having surface slope. The deep end of the IWKB profiles present reduced signal-to-noise ratio, which does not significantly affect the accuracy of the DOC, or the values of A(z), particularly for z≤DOC. There is, however, a potential for surface CS variation on the order of 10-20 MPa associated with the finite resolution of the IWKB-based stress-profile extraction.

Preparation of a hybrid stress profile involves splicing a surface spike profile obtained by the applicable inverse-WKB method as discussed above onto a through-thickness stress profile obtained by the RNF method, and forced balanced and scaled to agree with center tension measured by SCALP.

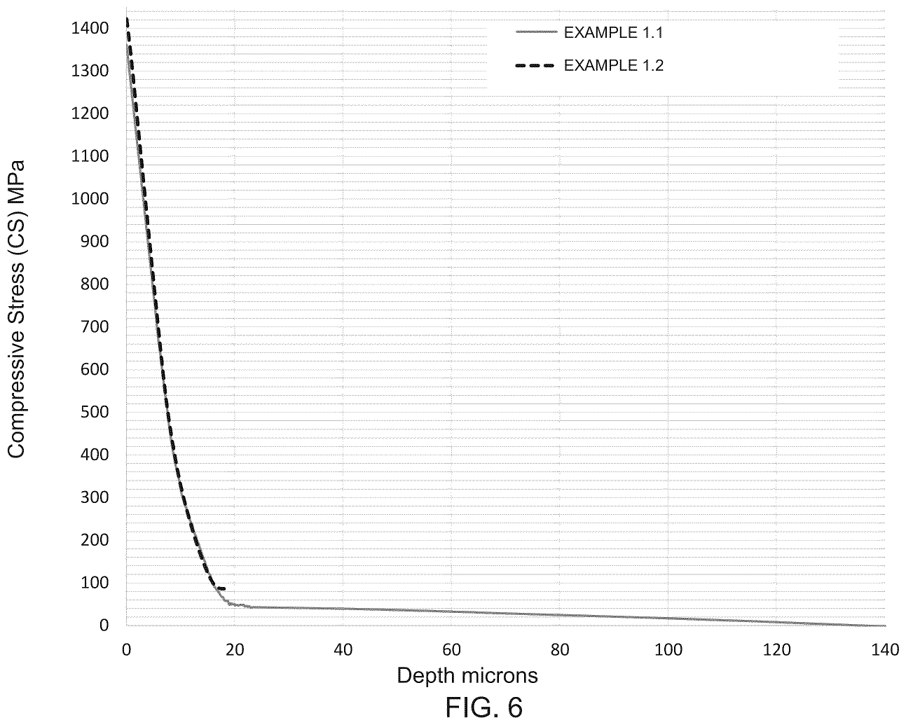

As utilized herein, the K_{IC} fracture toughness is measured by a double cantilever beam (DCB) method. The K_{IC} values were measured on glass-based substrates before being ion exchanged to form the glass-based articles. The DCB specimen geometry is shown in FIG. 5 with parameters being the crack length a, applied load P, cross-sectional dimensions wand 2h, and the thickness of the crack-guiding groove b. The samples were cut into rectangles of width 2h=1.25 cm and a thickness ranging from, w=0.3 mm to 1 mm, with the overall length of the sample, which is not a critical dimension, varying from 5 cm to 10 cm. A hole was drilled on both ends with a diamond drill to provide a means of attaching the sample to a sample holder and to the load. A crack “guiding groove” was cut down the length of the sample on both flat faces using a wafer dicing saw with a diamond blade, leaving a “web” of material, approximately half the total plate thickness (dimension b in FIG. 5), with a height of 180 μm corresponding to the blade thickness. The high precision dimensional tolerances of the dicing saw allow for minimal sample-to-sample variation. The dicing saw was also used to cut an initial crack where a=15 mm. As a consequence of this final operation a very thin wedge of material was created near the crack tip (due to the blade curvature) allowing for easier crack initiation in the sample. The samples were mounted in a metal sample holder with a steel wire in the bottom hole of the sample. The samples were also supported on the opposite end to keep the samples level under low loading conditions. A spring in series with a load cell (FUTEK, LSB200) was hooked to the upper hole which was then extended, to gradually apply load, using rope and a high precision slide. The crack was monitored using a microscope having a 5 μm resolution attached to a digital camera and a computer. The applied stress intensity, K_{P}, was calculated using the following equation (Ill):

$${K}_{P} = [ \frac{P \cdot a}{{( w \cdot b )}^{0.5} {h}^{1.5}} ] [ 3.47 + 2.32 \frac{h}{a} ]$$

For each sample, a crack was first initiated at the tip of the web, and then the starter crack was carefully sub-critically grown until the ratio of dimensions a/h was greater than 1.5, as per equation (III) to accurately calculate stress intensity. At this point the crack length, a, was measured and recorded using a traveling microscope with 5 μm resolution. A drop of toluene was then placed into the crack groove and wicked along the length of groove by capillary forces, pinning the crack from moving until the fracture toughness is reached. The load was then increased until sample fracture occurred, and the critical stress intensity K_{IC} calculated from the failure load and sample dimensions, with K_{P} being equivalent to K_{IC} due to the measurement method.

### Ion Exchange (IOX) Treatment

Chemical strengthening of glass substrates having base compositions is done by placing the ion-exchangeable glass substrates in a molten bath containing cations (e.g., K+, Na+, Ag+, etc) that diffuse into the glass while the smaller alkali ions (e.g., Na+, Li+) of the glass diffuse out into the molten bath. The replacement of the smaller cations by larger ones creates compressive stresses near the top surface of glass. Tensile stresses are generated in the interior of the glass to balance the near-surface compressive stresses.

There are processing challenges to make strengthened glasses with high CS and deep DOL or DOC, which involve trade-offs on timing and resulting stress profiles.

Herein, ion exchange techniques include three types of strengthening processes: single ion exchange (SIOX), double ion exchange (DIOX), and triple ion exchange (TIOX).

SIOX is a one-step process (Step 1) which is simple and a cost-effective way to conduct ion exchange. Step 1 includes a bath of mostly potassium (e.g, 90% by weight or more). CS and DOL of SIOX are determined primarily by bath composition, IOX temperature and time, and they are inversely correlated to each other. This means that to achieve a higher CS, the IOX time cannot be long and, thus, the DOL cannot be increased so deeply.

DIOX is two-step process where a first step (Step 1) is designed to build a deep DOC and a second step (Step 2) is designed to have a high CS with a shorter DOL. DIOX is an advantageous process to build with high CS and deep DOC to withstand damage introduction failure.

TIOX is a three-step ion exchange (TIOX) where a third step (Step 3) is used in conjunction with Step 2 and Step 1.

In some implementations, methods comprise: conducting a primary ion exchange treatment (e.g. Step 1) including a primary ion exchange bath that comprises greater than or equal to 90% by weight of potassium nitrate to achieve a stress profile of a glass article comprising opposing first and second surfaces defining a body of the article having a thickness (t). The stress profile comprises: a spike region extending from the first surface to a knee located at a depth of layer (DOL); a peak compressive stress (CSₘₐₓ) of the spike region being greater than or equal to 1150 MPa; a tail region extending from the knee to a center of the glass article having a central tension (CT) and including a depth of compression (DOC); a compressive stress integral at a depth of 5 micrometers that is greater than or equal to 4.75 MPa·millimeter; and the compressive stress integral at a depth of 8 micrometers that is greater than or equal to 6.7 MPa·millimeter.

In some implementations, the primary ion exchange treatment comprises a single ion exchange treatment, wherein the primary ion exchange bath comprises greater than or equal to 99% by weight potassium nitrate.

In some implementations, the primary ion exchange bath comprises greater than or equal to 90% to less than or equal to 99% by weight potassium nitrate, and greater than or equal to 1% to less than or equal to 10% by weight of sodium nitrate and/or lithium nitrate.

In some implementations, the primary ion exchange bath comprises greater than or equal to 95% to less than or equal to 99% by weight potassium nitrate, and greater than or equal to 1% to less than or equal to 5% combined sodium nitrate and lithium nitrate.

In some implementations, a secondary ion exchange treatment follows the primary ion exchange treatment including a secondary ion exchange bath that comprises only potassium-based salts including potassium nitrate and/or potassium carbonate.

In some implementations, a tertiary ion exchange treatment follows the secondary ion exchange treatment.

In some implementations, a heat treatment follows the secondary ion exchange treatment.

In some implementations, the methods herein involve ion exchange that can be achieved by thermal-diffusion, electro-diffusion processes involving molten salt admixtures of Li+, Na+, K+, Rb+, Cs+, Ag+, TI+.

### General Overview of Properties of Glass Articles

There is interest in using 3D-shaped cover glass on heavier consumer-electronic devices, such as head sets. With such devices and 3D shapes, it is difficult to limit the impact stresses that occur during a drop event. Chemically strengthened glass protected by state-of-the-art profiles effective for devices such as phones, tablets, laptops, and smart watches, may not be adequately effective in protecting 3D-shaped cover glass under the conditions of impact stresses exceeding 1 GPa and more. To enable use of glass on such heavier devices, stronger protection is advantageous, which warrants glasses with new inventive stress profiles. Chemical strengthening glasses with high CS and deep DOL or DOC are desired in the consumer electronic devices/display, for example headsets, accordingly. To withstand a high velocity impact, a strengthening glass desirably have a very high CS to overcome over-stress failure and a deep DOL or DOC to overcome damage-introduction failure.

Glass articles herein have stress profiles that are designed to have improved protection of glass devices from strong impacts. Such devices include 3D devices having preferably thicknesses of greater than or equal to 0.70 millimeters to less than or equal to 1.3 millimeters. High compressive stress at the surface (Csmax) in combination with compressive stress integral to desired depths improve survival of high stress-impact events.

Implementations herein include a glass articles (cover glasses) comprising a stress profile with front-loaded compressive stress. The front-loaded profile thus features high surface compressive stress (greater than or equal to 1000 MPa, preferably greater than or equal to 1050 MPa, preferably greater than or equal to 1100 MPa, more preferably greater than or equal to 1150 MPa, even greater than or equal to 1200 MPa), and also feature high compressive stress extended over a significant depth range, expressed through a parameter that an integrated compressive stress over depths above 5 microns and extending to progressively higher depths, up to 12, 15, 20, 25, and even 30 microns, stay above a value that associates with substantially improved probability of surviving high-stress impact events by offering significantly improved retained strength in that depth range over prior-art compressive-stress profiles. In one or more implementations, the integrated compressive stress in the first 12 microns is greater than or equal to 8 MPa*mm, preferably greater than or equal to 9 MPa*mm.

In one aspect, the stress profiles of glass articles herein utilizing higher fracture toughness and higher Young's modulus feature higher surface CS than prior-art profiles for comparative glass articles herein utilizing lower fracture toughness and lower Young's modulus. In some implementations, the glass articles comprise an alkali aluminosilicate central composition, including a Young's modulus that is greater than or equal to 76 GPa or greater than or equal to 80 GPa; and/or a facture toughness of greater than or equal to 0.78; and/or a Na₂O/Li₂O molar ratio in a range of greater than or equal to 1.5 to less than or equal to 2.1.

In another aspect, the stress profiles herein feature higher stress area to target depths such as 5, 8, 12, 16, 20, or 25 microns. According to another aspect of the invention, it is also preferable that the glass have high fracture toughness (above 0.75 by double cantilever beam (DCB) method, even better above 0.8).

In some implementations, articles including the front-loaded stress profile are combined with a surface etching, which includes removal of an amount of material, including, for example, from 0.2 to 20 microns per side, preferably from 0.3 to 8 microns per side, more preferably from 0.5 to 3 microns per side, even more preferably from 1 to 2.5 microns per side, to reduce depths of pre-existing flaws, or reduce sharpness of pre-existing flaws, in order to improve the strength of residual flaws to a level that can withstand the high-stress contact events. In some desired profiles, the surface CS is designed to be less than 1100 MPa, because the profiles herein may show adequate performance when combined with some surface etching in which material is etched from the glass surface to improve the strength of pre-existing flaws by eliminating them, reducing their depth, and/or changing their shape through the etching process. In such cases, a combination with higher stress area to at least one of the depths of 5, 8, 12, 16, 20, or 25 micron, provides superior fracture resistance for certain flaws, compared to prior-art profiles. These flaws include edge-finishing flaws which may be very costly to reduce to below 10-micron size when the cover-glass article has a complex 3D shape. Other flaws that may need such deeper protection include some 3D-forming flaws. Furthermore, it is common for the glass surface to develop flaws during service, including scratches that may generate median cracks that go deeper than 10 microns, sometimes as deep as 15, 20, or even 25 microns. Increasing the compressive-stress area to these depths can help increase the retained strength of such flaws to a significantly larger extent than prior-art profiles would provide.

Advantages of the profiles and articles herein featuring the front-loaded profiles is that the articles have significant probability of surviving high-stress events, featuring stresses significantly exceeding 1 GPa. Also, some of the profiles herein allow surviving multiple high-stress events, and also allow non-trivial probability of surviving high-stress events after some wear and tear (e.g., after sustaining small scratches during service). Without intending to be bound by theory, a reasonable hypothesis regarding the extended survivability of high-stress events even after some wear is that the front-loaded, high-CS profiles offer increased resistance to forming deep flaws, in addition to increased strength of flaws under load.

Articles according to the stress profiles herein solve the problem of providing adequate strength for cover glasses for products that may experience during service particularly high tensile stresses at impact events. Such impact events include drops or falls, in which the product experiences high-deceleration impacts occurring at speed of several m/s at the beginning of the deceleration. Peak stresses occurring on the glass during such events exceed 1 GPa, sometimes exceed even 1.3 or 1.5 GPa. Any of the prior-art chemically strengthened glass articles would not survive such events when pre-existing flaws have depth of even just a few microns. Some comparative profiles, particularly in Li-based glasses, have high surface CS and significant stress at large depths, but the CS drops too quickly from the surface to a knee-point, and the deeper portion of the stress profile does not have enough compressive stress to withstand fracture in high-stress events. Mobile-phone systems rarely experience impact stresses in excess of 300 MPa. On the other hand, some heavier 3D systems could experience significantly higher stresses over 1 GPa. In this case, failure modes involving relatively shallow flaws subjected to very high impact stresses can become active and protecting against deep flaws causing breakage under more moderate stresses (as in mobile phones) may become a lower priority. For example, measures could be taken to limit the probability of forming deep flaws, while it may be difficult to prevent very high stresses from occurring. For situations like that, herein are disclosed front-loaded high-CS profiles, featuring not only very high surface CS, but also high CS-area in the first 12 micron, but preferably the first 15 micron, 20 micron, or 25 micron, would provide a non-negligible increase in retained strength, to a degree that makes a qualitative difference in survivability of these high-stress events. Based on this qualitative difference, a device equipped with any cover-glass article herein, would become commercially viable for the first time, unlike a device equipped with any prior-art cover glass.

Alkali aluminosilicate glasses have good ion exchangeability, and chemical strengthening processes have been used to achieve high strength and high toughness properties in alkali aluminosilicate glasses. Sodium aluminosilicate glasses are highly ion exchangeable glasses with high glass formability and quality. Lithium aluminosilicate glasses are highly ion exchangeable glasses with high glass quality. The substitution of Al₂O₃ into the silicate glass network increases the interdiffusivity of monovalent cations during ion exchange. By chemical strengthening in a molten salt bath (e.g., KNO₃ or NaNO₃), glasses with high strength, high toughness, and high indentation cracking resistance can be achieved. The stress profiles achieved through chemical strengthening may have a variety of shapes that increase the drop performance.

Therefore, lithium aluminosilicate glasses with good physical properties, chemical durability, and ion exchangeability have drawn attention for use as cover glass. Through different ion exchange processes, greater central tension (CT), depth of compression (DOC), and high compressive stress (CS) can be achieved.

In implementations of glass compositions described herein, the concentration of constituent components (e.g., SiO₂, Al₂O₃, Li₂O, and the like) are given in mole percent (mol %) on an oxide basis, unless otherwise specified. It should be understood that any of the variously recited ranges of one component may be individually combined with any of the variously recited ranges for any other component.

In the glass articles, there is an alkali metal oxide having a non-zero concentration that varies from one or both of first and second surfaces to a depth of layer (DOL) with respect to the metal oxide. A stress profile is generated due to the non-zero concentration of the metal oxide(s) that varies from the first surface. The non-zero concentration may vary along a portion of the article thickness. This change may be measured by known methods in the art including microprobe.

In some implementations, the variation in concentration may be continuous along thickness segments in the range from about 10 micrometers to about 30 micrometers. In some implementations, the concentration of the alkali metal oxide decreases from the first surface to a value between the first surface and the second surface and increases from the value to the second surface.

The concentration of alkali metal oxide may include more than one metal oxide (e.g., a combination of Na₂O and K₂O). In some implementations, where two metal oxides are utilized and where the radius of the ions differ from one or another, the concentration of ions having a larger radius is greater than the concentration of ions having a smaller radius at shallow depths, while at deeper depths, the concentration of ions having a smaller radius is greater than the concentration of ions having larger radius.

The concentration of the alkali metal oxide may be determined from a baseline amount of the metal oxide in the glass substrate ion exchanged to form the glass article, for example, the concentration may be determined relative to the base composition.

In one or more implementations, the glass article comprises: tin the range of 0.3 mm to 1.5 mm, and all values and subranges therebetween; and/or t may be less than or equal to 1.2 mm, less than or equal 1.1 mm, less than or equal 1.0 mm, less than or equal to 0.9, less than or equal to 0.80 mm, less than or equal to 0.70 mm, less than or equal to 0.65 mm, less than or equal to 0.50 mm and/or greater than or equal to 0.5 mm, greater than or equal to 0.6 mm, greater than or equal to 0.7 mm, greater than or equal to 0.8 mm, including all values and subranges therebetween. In one or more implementations, the thickness t is in a range of 0.70 millimeters to 1.3 millimeters.

In one or more implementations, the glass article comprises: a maximum compressive stress (CSₘₐₓ) that is greater than or equal to greater than or equal to 950 MPa, greater than or equal to 1000 MPa, greater than or equal to 1050 MPa, greater than or equal to 1100 MPa, greater than or equal to 1150 MPa, greater than or equal to 1200 MPa, greater than or equal to 1250 MPa, greater than or equal to 1300 MPa, greater than or equal to 1350 MPa, greater than or equal to 1400 MPa, including all values and subranges therebetween.

In one or more implementations, the glass article comprises: a compressive stress integral at a depth of 5 micrometers that is greater than or equal to 4.75 MPa·millimeter, and the compressive stress integral at a depth of 8 micrometers is greater than or equal to 6.7 MPa·millimeter; optionally including one or more of the following: the compressive stress integral at a depth of 12 micrometers is greater than or equal to 8.0 MPa·millimeter, including greater than or equal to 8.3 MPa·millimeter; the compressive stress integral at a depth of 16 micrometers is greater than or equal to 8.3 MPa·millimeter; the compressive stress integral at a depth of 20 micrometers is greater than or equal to 14 MPa·millimeter; the compressive stress integral at a depth of 25 micrometers is greater than or equal to 14.5 MPa·millimeter; and the compressive stress integral at a depth of 30 micrometers is greater than or equal to 17 MPa·millimeter.

In one or more implementations, the glass article comprises: a compressive stress integral at a depth of 5 micrometers that is greater than or equal to 4.75 MPa·millimeter, and the compressive stress integral at a depth of 8 micrometers is greater than or equal to 7 MPa·millimeter; optionally including one or more of the following: the compressive stress integral at a depth of 12 micrometers is greater than or equal to 10.9 MPa·millimeter; the compressive stress integral at a depth of 16 micrometers is greater than or equal to 13.1 MPa·millimeter; the compressive stress integral at a depth of 20 micrometers is greater than or equal to 14.1 MPa·millimeter; the compressive stress integral at a depth of 25 micrometers is greater than or equal to 14.9 MPa·millimeter; and the compressive stress integral at a depth of 30 micrometers is greater than or equal to 17 MPa·millimeter.

In one or more implementations, the glass article comprises: a tensile stress factor Kₜ, which is a frangibility limit having units of stress-intensity factor, e.g., MPa√m. As utilized herein, the quantity Kₜ is the tensile-stress factor given by equation (1):

$$Kt = \sqrt{{\int }_{{DOC}_{1}}^{{DOC}_{2}} {σ}^{2} ( z ) dz} , \qquad ( I )$$

where σ is represented by one of the in-plane components as the in-plane components are presumed to be equal), and z is the position in the thickness direction. To obtain the values of Kt in units of MPa√m, the stress values under the integral should be in MPa, while the thickness position scale z should be in m.

In some implementations, the glass article contains ion-exchanged sodium and potassium. In some implementations, the glass article contains ion-exchanged lithium, sodium, and potassium.

In some implementations, the glass article contains ion exchanged lithium, sodium, potassium and metal ion dopants such as silver, copper, zinc, titania etc. to introduce additional functionalities such as anti-microbial, self-cleaning, and the like.

Aspect (a). A glass article comprising: opposing first and second surfaces defining a body of the article having a thickness (t); a stress profile of the body comprising: a spike region extending from the first surface to a knee located at a depth of layer (DOL); a peak compressive stress (CSₘₐₓ) of the spike region being greater than or equal to 1150 MPa; a tail region extending from the knee to a center of the glass article having a central tension (CT) and including a depth of compression (DOC); a compressive stress integral at a depth of 5 micrometers that is greater than or equal to 4.75 MPa·millimeter; and the compressive stress integral at a depth of 8 micrometers that is greater than or equal to 6.7 MPa·millimeter.

Aspect (b). The glass article of aspect (a), wherein the t is in a range of 0.30 millimeters to 1.5 millimeters.

Aspect (c). The glass article of aspect (a) or (b), wherein the DOC is greater than or equal to 0.020·t, including greater than or equal to 0.023·t, greater than or equal to 0.028·t, greater than or equal to 0.030·t, greater than or equal to 0.031·t, greater than or equal to 0.032·t, greater than or equal to 0.034·t, or greater than or equal to 0.036·t.

Aspect (d). The glass article of any one of aspects (a) to (c), including one or more of the following: the compressive stress integral at a depth of 12 micrometers is greater than or equal to 8.0 MPa·millimeter; and the compressive stress integral at a depth of 16 micrometers is greater than or equal to 8.3 MPa·millimeter.

Aspect (e). The glass article of any one of aspects (a) to (d), wherein the peak compressive stress (CSₘₐₓ) of the spike region is greater than or equal to 1200 MPa, 1250 MPa, 1300 MPa, or 1350 MPa.

Aspect (f). The glass article of any one of aspects (a) to (e), wherein the compressive stress integral at a depth of 5 micrometers is greater than or equal to 5 MPa·millimeter.

Aspect (g). The glass article of any one of aspects (a) to (f) comprising an alkali aluminosilicate central composition having a sodium oxide content in a range of greater than or equal to 4.0 mol % to less than or equal to 15.0 mol % Na₂O.

Aspect (h). The glass article of any one of aspects (a) to (g) comprising an alkali aluminosilicate central composition having a Young's modulus that is greater than or equal to 76 GPa or greater than or equal to 80 GPa; and/or a facture toughness of greater than or equal to 0.78; and/or a Na₂O/Li₂O molar ratio in a range of greater than or equal to 1.5 to less than or equal to 2.1.

Aspect (i). A glass article comprising: opposing first and second surfaces defining a body of the article having a thickness (t) of greater than or equal to 0.70 millimeters to less than or equal to 1.3 millimeters; a stress profile of the body comprising: a spike region extending from the first surface to a knee located at a depth of layer (DOL); a peak compressive stress (CSₘₐₓ) of the spike region being greater than or equal to 1000 MPa; a tail region extending from the knee to a center of the glass article having a central tension (CT) and including a depth of compression (DOC); and a compressive stress integral at a depth of 5 micrometers that is greater than or equal to 4.75 MPa·millimeter and the compressive stress integral at a depth of 8 micrometers that is greater than or equal to 7.0 MPa·millimeter.

Aspect (j). The glass article of aspect (i) including one or more of the following: the compressive stress integral at a depth of 12 micrometers is greater than or equal to 10.9 MPa·millimeter; the compressive stress integral at a depth of 16 micrometers is greater than or equal to 13.1 MPa·millimeter; the compressive stress integral at a depth of 20 micrometers is greater than or equal to 14.1 MPa·millimeter; and the compressive stress integral at a depth of 25 micrometers is greater than or equal to 14.9 MPa·millimeter.

Aspect (k). The glass article of aspect (i) or (j) comprising a 3D configuration.

Aspect (l). The glass article of any one of aspects (i) to (k), wherein the peak compressive stress (CSₘₐₓ) of the spike region is greater than or equal to 1100 MPa or 1150 MPa.

Aspect (m). The glass article of any one of aspects (i) to (k) comprising an alkali aluminosilicate central composition.

Aspect (n). The glass article of aspect (m), wherein the alkali aluminosilicate central composition has a Young's modulus that is greater than or equal to 76 GPa or greater than or equal to 80 GPa; and/or a facture toughness of greater than or equal to 0.78; and/or a Na₂O/Li₂O molar ratio in a range of greater than or equal to 1.5 to less than or equal to 2.1.

Aspect (o). The glass article of aspect (m), wherein the alkali aluminosilicate central composition comprises: about 50 mol % to about 69 mol % SiO₂; about 12.5 mol % to about 25 mol % Al₂O₃; about 0 mol % to about 8 mol % B₂O₃; about 0.01 mol % to about 2 mol % K₂O; about 11.0 mol % to about 15.0 mol % Na₂O; and about 0.5 mol % to about 10 mol % Li₂O.

Aspect (p). The glass article of any one of aspects (i) to (o) comprising the compressive stress integral at a depth of 30 micrometers of greater than or equal to 16 MPa·millimeter, or 17 MPa·millimeter.

Aspect (q). The glass article of any one of aspects (i) to (p), wherein the DOC is greater than or equal to 20 micrometers or 21 micrometers or 22 micrometers or 23 micrometers or 24 micrometers or 25 micrometers or 26 micrometers or 27 micrometers or 28 micrometers or and optionally is less than 30 micrometers.

Aspect (r). The glass article of any one of aspects (i) to (p), wherein the DOC is greater than or equal to 30 micrometers.

Aspect (s). A consumer electronic product comprising: a housing having a front surface, a back surface, and side surfaces; electrical components provided at least partially within the housing, the electrical components including at least a controller, a memory, and a display, the display being provided at or adjacent the front surface of the housing; and the glass article of any one of aspects (a) to (r) disposed over the display.

Aspect (t). A method of making a glass article comprising opposing first and second surfaces defining a body of the article having a thickness (t), and a stress profile of the body, the method comprising: conducting a primary ion exchange treatment including a primary ion exchange bath that comprises greater than or equal to 90% by weight of potassium nitrate to achieve a stress profile of the body comprising: a spike region extending from the first surface to a knee located at a depth of layer (DOL); a peak compressive stress (CSₘₐₓ) of the spike region being greater than or equal to 1150 MPa; a tail region extending from the knee to a center of the glass article having a central tension (CT) and including a depth of compression (DOC); a compressive stress integral at a depth of 5 micrometers that is greater than or equal to 4.75 MPa·millimeter; and the compressive stress integral at a depth of 8 micrometers that is greater than or equal to 6.7 MPa·millimeter.

Aspect (u). The method of aspect (t), wherein the primary ion exchange treatment comprises a single ion exchange treatment, wherein the primary ion exchange bath comprises greater than or equal to 99% by weight potassium nitrate.

Aspect (v). The method of aspect (t), wherein the primary ion exchange bath comprises greater than or equal to 90% to less than or equal to 99% by weight potassium nitrate, and greater than or equal to 1% to less than or equal to 10% by weight of sodium nitrate and/or lithium nitrate.

Aspect (w). The method of aspect (v), wherein the primary ion exchange bath comprises greater than or equal to 95% to less than or equal to 99% by weight potassium nitrate, and greater than or equal to 1% to less than or equal to 5% combined sodium nitrate and lithium nitrate.

Aspect (x). The method of aspect (t), wherein a secondary ion exchange treatment follows the primary ion exchange treatment including a secondary ion exchange bath that comprises only potassium-based salts including potassium nitrate and/or potassium carbonate.

Aspect (y) is a glass article comprising: opposing first and second surfaces defining a body of the article having a thickness (t) of greater than or equal to 0.50 millimeters to less than or equal to 0.83 millimeters; a stress profile of the body comprising: a spike region extending from the first surface to a knee located at a depth of layer (DOL); a peak compressive stress (CSₘₐₓ) of the spike region being greater than or equal to 1700 MPa or greater than or equal to 1750 MPa; a tail region extending from the knee to a center of the glass article having a central tension (CT) and including a depth of compression (DOC); and a compressive stress integral at a depth of 5 micrometers that is greater than or equal to 7 MPa·millimeter.

Aspect (z) is aspect (y) comprising an alkali aluminosilicate central composition.

Aspect (aa) is aspect (z) having a central composition that has a Na₂O/Li₂O molar ratio in a range of greater than or equal to 5 to less than or equal to 7.

Aspect (bb) is aspect (z) or (aa) the alkali aluminosilicate central composition comprises: about 50 mol % to about 69 mol % SiO₂; about 12.5 mol % to about 25 mol % Al₂O₃; about 15.0 mol % to about 20.0 mol % Na₂O; and about 0.5 mol % to about 5 mol % Li₂O.

Aspect (cc) is any one of aspects (y) to (bb) comprising one or more of the following: the compressive stress integral at a depth of 8 micrometers is greater than or equal to 10 MPa·millimeter; the compressive stress integral at a depth of 12 micrometers is greater than or equal to 13 MPa·millimeter; the compressive stress integral at a depth of 16 micrometers is greater than or equal to 14 MPa·millimeter; and the compressive stress integral at a depth of 20 micrometers is greater than or equal to 14.5 MPa·millimeter.

### Glass Substrates

Examples of glasses that may be used as substrates may include soda-lime silicate glass compositions or alkali-alumino silicate glass compositions or alkali-containing aluminoborosilicate glass compositions, though other glass compositions are contemplated such as soda-lime silicate glass. Specific examples of glass substrates that may be used include but are not limited to a soda-lime silicate glass, an alkali-alumino silicate glass, an alkali-containing borosilicate glass, an alkali-containing aluminoborosilicate glass, or an alkali-containing phosphate glass. In an implementation, the glass substrate comprises an alkali-containing lithium alumino silicate composition. The glass substrates have base compositions that may be characterized as ion exchangeable. As used herein, “ion exchangeable” means that a substrate comprising the composition is capable of exchanging cations located at or near the surface of the substrate with cations of the same valence that are either larger or smaller in size. In some implementations, the glass substrate comprises an alkali content of greater than 2 mol %.

In one or more implementations, glass substrates may include a lithium-containing aluminosilicate. In an implementation, a glass substrate comprises a Na₂O/Li₂O molar ratio in a range of greater than or equal to 1.5 to less than or equal to 2.1, including all values and ranges therebetween, including greater than or equal to 1.8 to less than or equal to 2.0.

In an implementation, a glass substrate comprises a central composition including: about 50 mol % to about 69 mol % SiO₂; about 12.5 mol % to about 25 mol % Al₂O₃; about 11.0 mol % to about 15.0 mol % Na₂O; about 0.5 mol % to about 10 mol % Li₂O; about 0.01 mol % to about 2 mol % K₂O. In some implementations, the glass substrate further comprises one or more of the following ingredients: about 0 mol % to about 8 mol % B₂O₃; about 0.5 mol % to about 2 mol % CaO; about 0.5 mol % to about 2 mol % MgO; about 0.1 mol % to about 1 mol % ZnO; about 0.1 mol % to about 0.5 mol % SnO₂; about 0 mol % to about 0.1 mol % TiO₂; about 0 mol % to about 0.1 mol % Fe₂O₃; about 0 mol % to about 0.1 mol % P₂O₅; about 0 mol % to about 0.1 mol % ZrO₂; and about 0 mol % to about 0.1 mol % MnO₂.

In implementations, the glass substrates may be formed from any composition capable of forming the stress profiles. In some implementations, the glass substrates may be formed from the glass compositions described in U.S. application Ser. No. 16/202,691 titled “Glasses with Low Excess Modifier Content,” filed Nov. 28, 2018, the entirety of which is incorporated herein by reference. In some implementations, the glass articles may be formed from the glass compositions described in U.S. application Ser. No. 16/202,767 titled “Ion-Exchangeable Mixed Alkali Aluminosilicate Glasses,” filed Nov. 28, 2018, the entirety of which is incorporated herein by reference.

The glass substrates may be characterized by the manner in which it may be formed. For implementation, the glass substrates may be characterized as float-formable (i.e., formed by a float process), down-drawable and, in particular, fusion-formable or slot-drawable (i.e., formed by a down draw process such as a fusion draw process or a slot draw process). In implementations, the glass substrates may be roll formed.

Some implementations of the glass substrates described herein may be formed by a down-draw process. Overflow down-draw processes produce glass substrates having a uniform thickness that possess relatively pristine surfaces. Because the average flexural strength of the glass article is controlled by the amount and size of surface flaws, a pristine surface that has had minimal contact has a higher initial strength. In addition, overflow down-draw glass articles have a very flat, smooth surface that can be used in its final application without costly grinding and polishing.

Some implementations of the glass substrates may be described as fusion-formable (i.e., formable using a fusion draw process). The fusion process is an overflow down-draw process that uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass article. The fusion draw method offers the advantage that, because the two glass films flowing over the channel fuse together, neither of the outside surfaces of the resulting glass article comes in contact with any part of the apparatus. Thus, the surface properties of the fusion drawn glass article are not affected by such contact.

Some implementations of the glass substrates described herein may be formed by a slot draw process. The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous glass article and into an annealing region.

In one or more implementations, the glass substrates described herein may exhibit an amorphous microstructure and may be substantially free of crystals or crystallites. In other words, the glass substrates and glass articles exclude glass-ceramic materials in some implementations.

### End Products

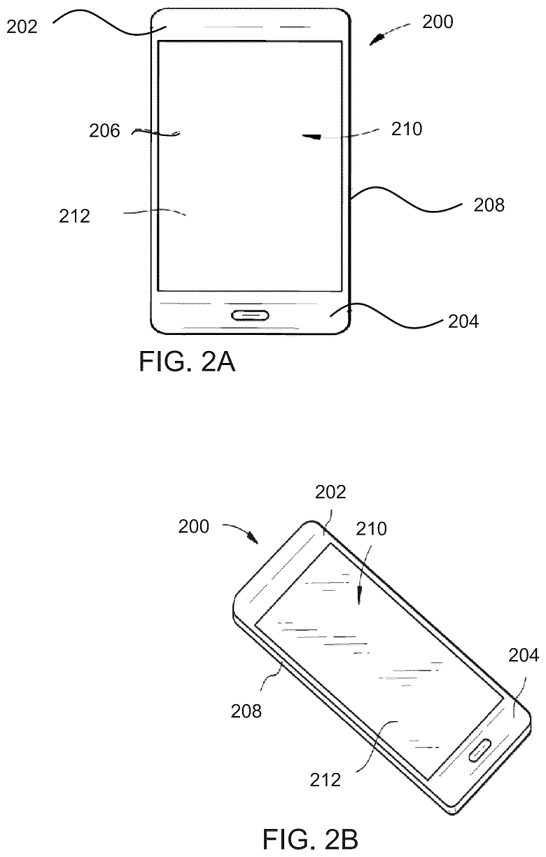

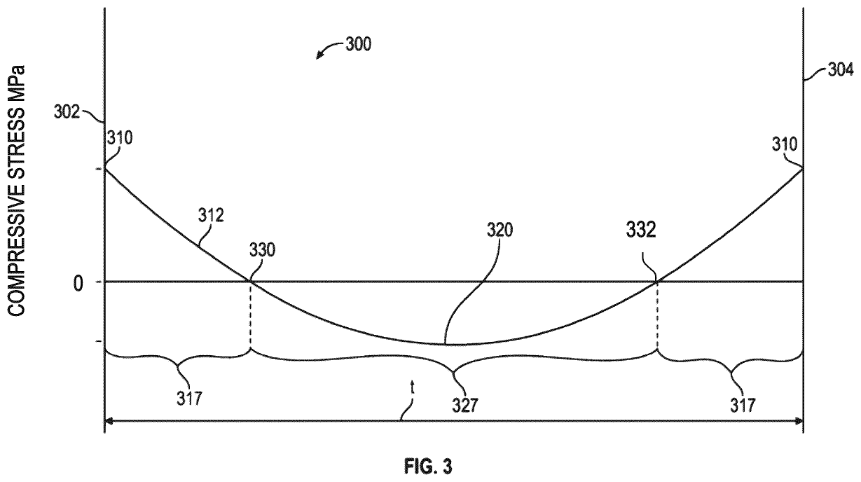

The glass articles disclosed herein may be incorporated into another article such as an article with a display (or display articles) (e.g., consumer electronics, including mobile phones, tablets, computers, navigation systems, and the like); architectural articles; transportation articles (e.g., automobiles, trains, aircraft, sea craft, etc.); appliance articles; defense articles; medical, packaging and safety articles; or any article that may benefit from some transparency, scratch-resistance, abrasion resistance or a combination thereof. An exemplary article incorporating any of the glass articles disclosed herein is shown in FIGS. 2A and 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In some implementations, the cover 212 and/or housing 202 may include any of the glass articles disclosed herein.

### EXAMPLES

Various implementations will be further clarified by the following examples.

Inventive glass substrates of Composition I and 0.8 or 1.2 millimeters nominal thicknesses were ion exchanged under various conditions. Implementations herein are not limited to 0.8 millimeters or 1.2 millimeters thickness. Advantageous stress profiles could be replicated at other thicknesses, such as 0.5 mm to 1.3 mm, with very minor changes in the ion-exchange conditions. In some cases, adjustments may be made to avoid frangibility, if that is important for the application.

Composition I had the following ingredients: 0.03 mol % K₂O; 11.73 mol % Na₂O; 5.83 mol % Li₂O; 18.52 mol % Al₂O₃; 59.16 mol % SiO₂; 1.71 mol % CaO; 1.87 mol % MgO; 0.91 mol % ZnO; 0.11 mol % SnO₂; 0.06 mol % TiO₂; 0.02 mol % Fe₂O₃; 0.02 mol % B₂O₃; 0.01 mol % P₂O₅; 0.01 mol % ZrO₂; 0.01 mol % MnO₂ (0.00 mol % SrO); and a Na₂O/Li₂O molar ratio of 2.

Comparative glass substrates of Composition II had the following ingredients: 64.13 mol % SiO₂; 15.98 mol % Al₂O₃; 10.86 mol % Na₂O; 0.03 mol % K₂O; 6.42 mol % Li₂O; 0.08 mol % MgO; 1.17 mol % ZnO; 0.04 mol % SnO₂; 1.24 mol % P₂O; and 0.02 mol % CaO; and a Na₂O/Li₂O molar ratio of 1.69.

Inventive glass substrates of Composition III and thicknesses ranging from 0.6 to 0.8 millimeters nominal thicknesses were ion exchanged under various conditions. Composition III had the following ingredients: 55.17 mol % SiO₂; 18.94 mol % Al₂O₃; 18.52 mol % Na₂O; 3.05 mol % Li₂O; 4.22 mol % MgO; 0.04 mol % CaO; 0.05 mol % SnO₂; and 0.004 mol % TiO₂; and a Na₂O/Li₂O molar ratio of 6.

Composition I has a fracture toughness of 0.789, which is slightly higher than that of Composition II, which is 0.76 (both measured by the double-cantilever beam (DCB) method). This can allow in some cases non-frangible glass articles with the profiles herein implemented in glass of Composition I, while the article would be frangible if a profile with similar stress to target depths were implemented in glass of Composition II. Composition III has a fracture toughness of 0.734 as measured by DCB. In addition, the glass of Composition I has a Young's modulus of 83 GPa and the glass of Composition III has a Young's modulus of 78.66 GPa, which are slightly higher than that of Composition II, which is 77 GPa, which assists in achieving higher compressive stress, which is one aspect of the stress profiles herein.

The articles of the examples were analyzed for their stress profiles, which were then processed to prepare integrated compressive stress graphs from the surface as a function of depth. Ion exchange conditions generally included a preheat of 20 minutes at 350° C. before the first step.

### Examples 1.1-1.2

Examples 1.1-1.2 are glass articles whose stress profiles were obtained by a 2-step ion-exchange process. The glass composition was Composition I, which had undergone a thermal cycle of 3D-forming, which rendered the glass fictive temperature somewhat lower than that of roller sheet forming, but significantly higher than the anneal-point fictive temperature. The first ion exchange step included a pre-heat followed by immersion in an ion exchange bath having 10% NaNO₃ and 90% KNO₃ by weight, with additive 0.5% silicic acid, at 430° C. for 9 hours. The second step of ion exchange was in a bath of KNO₃ only, with 0.5% silicic acid added, with immersion time of 1 hour at 430° C.

Table 1 provides a summary of Example 1.1-1.2 preparations.

TABLE 1

| | Substrate | IOX | |
|---|---|---|---|
| EXAMPLE | composition | STEPS | IOX Conditions^{(A)} |
| Example 1.1 | I | 2-steps | STEP 1: 90 wt % K NO₃/ |
| | | DIOX | 10 wt % NaNO₃ + at 430° |
| Example 1.2 | | | C., 9 hours + |
| | | | STEP 2: 100 wt % K NO₃ |
| | | | at 430° C., 1 hour |

^{(A)}STEP 1 and STEP 2 both included additive 0.5 wt % silicic acid.

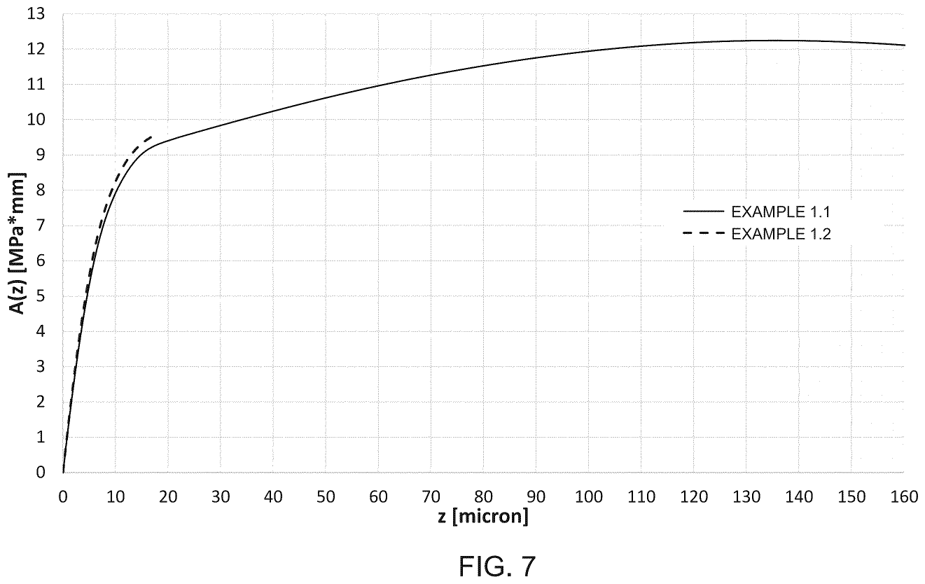

FIG. 6 shows stress profiles for Example 1.1-1.2 ion exchanged with the same DIOX process. The dashed line of Example 1.2 is only the near-surface profile, obtained by the inverse-IWKB method. The profile of Example 1.1 is a hybrid profile, wherein a surface spike profile obtained by the stepwise linear inverse-IWKB method was spliced onto a through-thickness stress profile obtained by the RNF method, and forced balanced and scaled to agree with center tension measured by SCALP. The profile of Example 1.1 has a slightly lower surface CS (about 1360 MPa), compared to surface CS of about 1422 MPa for Example 1.2. Such CS differences of a few % can occur depending on various secondary conditions such as loading density (how much glass surface is ion exchanged in unit salt volume) for example.

The stress profiles of FIG. 6 show a high-CS near-surface region rich in K-ions, extending to a depth of about 18 microns, and a slowly varying deep region of Na-ion enrichment. The depth of compression of Example 1.1 was about 135 microns, but the compressive stress at depths greater than 18 microns is relatively low (below about 100 MPa).

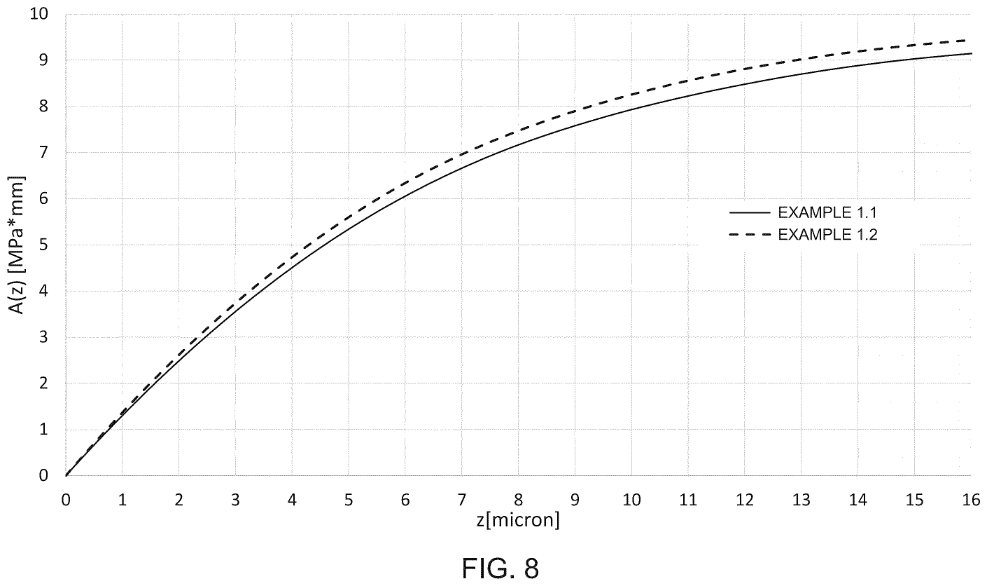

FIG. 7 shows integrated compressive stress (MPa·millimeter) from the surface to a target depth as a function of the target depth (microns), calculated for the DIOX profiles of FIG. 6. The majority of the compressive-stress area (about 75%) is concentrated in the first 16 microns for these examples. The integrated stress A(z) may be referred to as compressive-stress area (CSA), which can be represented as a function of the depth of integration z.

Considering the curve corresponding to Example 1.1 in FIG. 7, it is seen that the stress area to a target depth of 16 microns is about 9.1 MPa*mm, while the total stress area of the profile to the DOC (e.g., the maximum of A(z)) is about 12.2 MPa*mm, occurring at the DOC of about 135 microns as shown in FIG. 7. The profile is front-loaded, in the sense that the vast majority of the stress area is in the near-surface spike region (the first 16 microns that are most enriched in K-ions). Indeed, about 75% of the total compressive-stress area is contained in the first 16 microns.

FIG. 8 shows a zoomed view of the stress A(z) (compressive-stress area (CSA)) (MPa·millimeter) versus depth (micron) for the two DIOX profiles of FIG. 7 to the first 16 microns. The compressive stress area for Example 1.1 at least 5.3 MPa*mm at the target depth of 5 microns, 7.1 MPa*mm at a target depth of 8 microns, 8.4 MPa*mm at a target depth of 12 microns, and 9.1 MPa*mm at a target depth of 16 microns.

According to one or more implementations, the compressive stress area as a function of depth is greater than or equal to: 4.75 MPa*mm at a target depth of 5 microns, 6.7 MPa*mm at a target depth of 8 microns, 8 MPa*mm at a target depth of 12 microns, and/or 8.3 MPa*mm at a target depth of 16 microns.

Examples 1.1 and 1.2 represent one aspect herein, comprising surface compressive stress of at least 1150 MPa, preferably exceeding 1200 MPa, even more preferably exceeding 1250 MPa, 1300 MPa, or 1350 MPa, also comprising compressive-stress area of at least 4.75 MPa*mm to a depth of 5 microns. Additional implementations, in combination with these surface compressive stresses and such compressive-stress area of at a depth of 5 microns include one or more of the following: further higher CS-area to larger depth, such as 6.7 MPa*mm or more to a target depth of 8 microns, 8 MPa*mm or more to a target depth of 12 microns, and 8.3 MPa*mm or more to a target depth of 16 microns; and/or CS-area of at least 5 MPa*mm to 5 microns, 6.9 MPa*mm to 8 microns, 7.8 MPa*mm to 12 microns, and 8.6 MPa*mm to 16 microns; and/or an an alkali aluminosilicate central composition having: a Young's modulus that is greater than or equal to 76 GPa or greater than or equal to 80 GPa, and/or a facture toughness of greater than or equal to 0.78, and/or a Na₂O/Li₂O molar ratio in a range of greater than or equal to 1.5 to less than or equal to 2.1, and/or a composition comprising: about 50 mol % to about 69 mol % SiO₂; about 12.5 mol % to about 25 mol % Al₂O₃; about 0 mol % to about 8 mol % B₂O₃; about 0.01 mol % to about 2 mol % K₂O; about 11.0 mol % to about 15.0 mol % Na₂O; and about 0.5 mol % to about 10 mol % Li₂O; and/or the stress profile further comprising: a DOC greater than or equal to 0.030·t; and/or the article having a thickness in a range of 0.30 millimeters to 1.5 millimeters, including all values and subranges therebetween.

### Examples 2-4

Examples 2-4 and 21-25 are glass articles whose stress profiles were obtained by either a single step ion-exchange process (SIOX) or a 3-step ion-exchange process (TIOX). The glass composition was Composition I, which had undergone a thermal cycle of 3D-forming. The SIOX and TIOX stress profiles were designed for increased stress area to higher depths, especially 16 microns and above.

Table 2 provides a summary of Examples 2-4 and 21-25 preparations.

TABLE 2

| | Substrate | | |
|---|---|---|---|
| | composition & | IOX | |
| EXAMPLE | thickness | STEPS | IOX Conditions^{(A)} |
| Example 2 | I | Single | 100 wt % K NO₃ at 430° C., 17.5 hours |
| | 0.8 mm | SIOX | |
| Example 3 | I | Single | 100 wt % K NO₃ at 430° C., 24 hours |
| | | SIOX | |
| Example 4 | I | 3-steps | STEP 1: 100 wt % K NO₃ at 430° |
| | 0.8 mm | TIOX | C., 16 hours + |
| | | | STEP 2: 30 wt % K NO₃/70 wt % Na |
| | | | NO₃ at 430° C., 1 hour + |
| | | | STEP 3: 95 wt % K NO₃ + 5 wt % K₂ CO₃ |
| | | | at 400° C., 5 hours |
| Example 21 | I | 1-step | STEP 1: 95 wt % K NO₃ + 5 K₂ CO₃ at |
| | 0.8 mm | SIOX | 420° C., 18 hours |
| Example 22 | I | 1-step | STEP 1: 95 wt % K NO₃ + 5 K₂ CO₃ at |
| | 1.24 mm | SIOX | 420° C., 21.3 hours |
| Example 23 | III | 1-step | STEP 1: 95 wt % K NO₃ + 5 K₂ CO₃ at |
| | 0.8 mm | SIOX | 410° C., 5 hours |
| Example 24 | III | 1-step | STEP 1: 95 wt % K NO₃ + 5 K₂ CO₃ at |
| | 0.7 mm | SIOX | 410° C., 2 hours |
| Example 25 | III | 1-step | STEP 1: 95 wt % K NO₃ + 5 K₂ CO₃ at |
| | 0.6 mm | SIOX | 410° C., 5 hours |

^{(A)}STEP 1 and STEP 2 both included additive 0.5 wt % silicic acid.

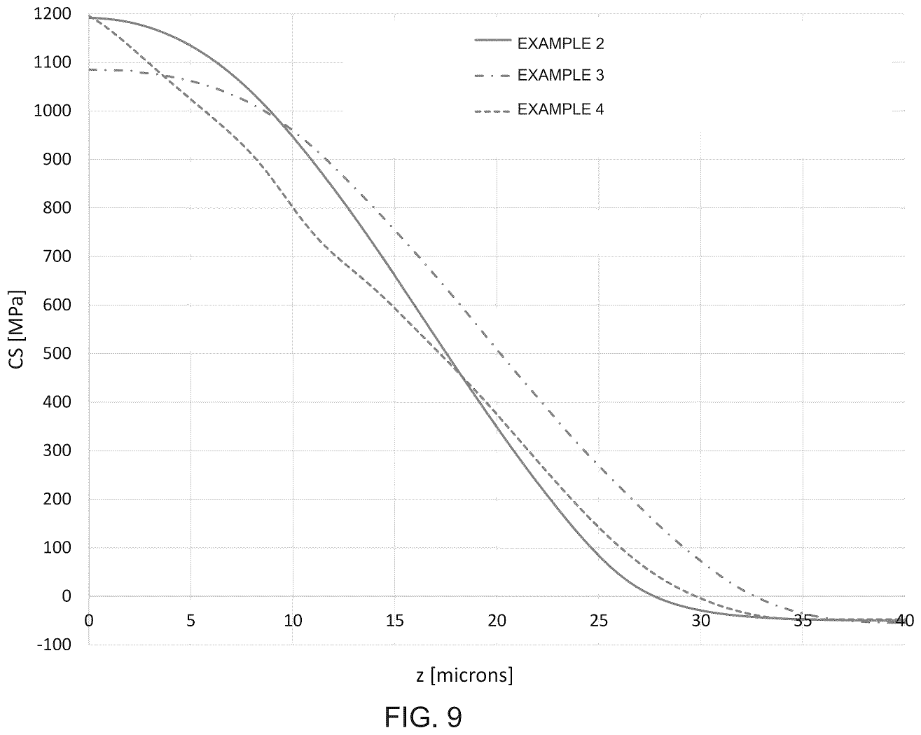

FIG. 9 shows stress profiles for Examples 2-4, which were obtained by use of inverse-WKB (IWKB). The stress profiles for Examples 2-3 (SIOX conditions) were obtained using the smooth IWKB method by Chiang as discussed above. The IWKB method for Example 4 was obtained by the stepwise linear IWKB method as discussed above.

Examples 23-25 represent one aspect of the invention herein, comprising surface compressive stress of at least 1700 MPa, preferably exceeding 1750 MPa, also comprising compressive-stress area of at least 7 MPa*mm to a depth of 5 microns. Additional implementations, in combination with these surface compressive stresses and such compressive-stress area of at a depth of 5 microns include one or more of the following: further higher CS-area to larger depth, such as 10 MPa*mm or more to a target depth of 8 microns, 13 MPa*mm or more to a target depth of 12 microns, 14 MPa*mm or more to a target depth of 16 microns, 14.5 MPa*mm or more to a target depth of 20 microns; and/or an an alkali aluminosilicate central composition having: a Na₂O/Li₂O molar ratio in a range of greater than or equal to 5 to less than or equal to 7, and/or a composition comprising: about 50 mol % to about 69 mol % SiO₂; about 12.5 mol % to about 25 mol % Al₂O₃; about 15.0 mol % to about 20.0 mol % Na₂O; and about 0.5 mol % to about 5 mol % Li₂O; and/or the stress profile further comprising: a DOC greater than or equal to 0.030·t; and/or the article having a thickness in a range of 0.50 millimeters to 0.83 millimeters, including all values and subranges therebetween.

### Comparative Examples a-C

Comparative Examples A-C are glass articles whose stress profiles were obtained by either a single step ion-exchange process (SIOX) or a 2-step ion-exchange process (DIOX). The glass composition was Composition II. Comparative Examples A-C are for auto-interior applications.

By way of background, chemically strengthened glass for auto-interior applications according to Comparative Example A has a high-CS surface spike with surface stress between 1000 and 1100 MPa, and depth of the spike extending to about 35 microns based Composition II, but with a much deeper K-enriched surface spike than what is practiced for phone covers (spike DOL of 35-40 microns instead of 8-9 microns). Comparative Example A (0.7 mm glass) has a profile that was obtained by ion exchange in a bath having 25% NaNO₃ and 75% KNO₃ at 430° C. for 8 hours, followed by a second step in 100% KNO₃ at 390° C. for 2.5 hours. The spike profile features surface CS of about 1060 MPa, and stress area of about 4.6 MPa*mm to a depth of 5 microns, 6.74 MPa*mm to a depth of 8 microns, 8.83 MPa*mm to a depth of 12 microns, and 10.2 MPa*mm to a depth of 16 microns.

Another auto-interior Comparative Example B was a 1.1-mm DIOX product based on Composition II, having step 1 done with 25% NaNO₃/75% KNO₃, 462° C. for 4 hours and step 1 of 100% KNO₃, 420° C., for 1.6 hours. The profile has surface CS of about 1030 MPa, and stress area of about 4.64 MPa*mm to a depth of 5 microns, 6.94 MPa*mm to 8 microns, 9.33 MPa*mm to a depth of 12 microns, and 11.05 MPa*mm to a depth of 16 microns. Furthermore, the area increases to about 12.23 MPa*mm to the depth of 20 microns, and 13.2 MPa*mm to the depth of 25 microns.

Table 3 provides a summary of Comparative Examples A-C preparations.

TABLE 3

| | Substrate | Thickness | IOX | |
|---|---|---|---|---|
| EXAMPLE | composition | mm | STEPS | IOX Conditions^{(A)} |
| Comparative | II | 0.7 | 2-step | STEP 1: 75 wt % K NO₃/25 wt % |
| Example A | | | DIOX | Na NO₃ at 430° C., |
| | | | | 8 hours + |
| | | | | STEP 2: 100 wt % K NO₃ at |
| | | | | 390° C., 2.5 hours |
| Comparative | II | 1.1 | 2-step | STEP 1: 75 wt % K NO₃/25 wt % |
| Example B | | | DIOX | Na NO₃ at 462° C., |
| | | | | 4 hours K + |
| | | | | STEP 2: 100 wt % K NO₃ at |
| | | | | 420° C., 1.6 hours |
| Comparative | II | 1.1 | single | 95 wt % K NO₃/5 wt % K₂ CO₃ at |
| Example C | | | SIOX | 390° C., 9.5 hours |

^{(A)}Each of STEP 1 and STEP 2 included additive 0.5 wt % silicic acid.

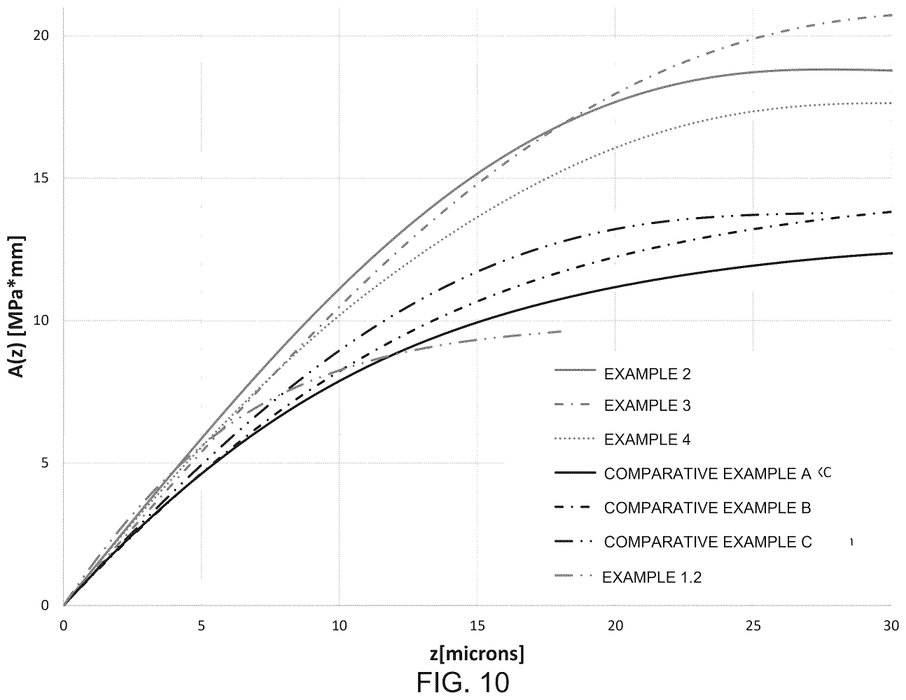

FIG. 10 shows integrated stress A(z) (compressive-stress area (CSA)) (MPa·millimeter) versus depth (micron) for the stress profiles of FIGS. 6 and 9, with the addition of the three Comparative Examples A-C based on glasses of Composition II.

While Examples 1.1-1.2 focused on boosting the stress in the first 5 microns as the primary objective, the stress profiles illustrated in FIG. 9 for Examples 2-4 are targeting more significant CS boost to larger depths. As such, they have CS and stress area that are less distinguished over the Comparative Examples A-B (of composition II) in the first 5 microns, but gain further in compressive-stress area at larger target depths such as 8, 12, 16, 20, and 25 microns. Such profiles can have extended life as they will retain high fracture resistance after some scratching during service. They are also better suited to withstand failures from occasional deeper edge flaws, such as 12 micron or 15-micron edge flaws. In one or more implementations, glass articles herein have compressive-stress areas of greater than or equal to: 5 MPa*mm at 5 microns, 8 MPa*mm at 8 microns, 11 MPa*mm at 12 microns, 13 and 14 MPa*mm at 16 micron, 15 and 16 MPa*mm at 20 micron, and 16 and 17 MPa*mm at 25 microns. Examples 2 and 3 have further higher areas at the larger depths, such as greater than 12 MPa*mm at 12 microns, greater than 15 MPa*mm at 16 microns, greater than 17 MPa*mm at 20 microns, and greater than 18 MPa at 25 microns. Example 3 has greater than 19 MPa*mm and greater than 20 MPa*mm at 25 microns.

Table 4.A provides CSmax (MPa) and DOC (microns) according to the respective stress profiles of FIG. 6 and FIG. 9 for Examples 1.1 and 2-4 and according to Comparative Examples A-B. Table 4.B provides detailed compressive-stress area for Examples 1.1 and 2-4 and Comparative Examples A-C according to FIG. 10. Tables 4.A and 4.B also include data for Examples 21-25.

TABLE 4.A

| | CSmax | DOC^{(B)} | |
|---|---|---|---|
| Example | (MPa) | (μm) | DOC/t |
| 1.1 | 1360 | 135 | 0.17 |
| 1.2 | 1422 | — | |
| 2 | 1192 | 28 | 0.035 |
| 3 | 1085 | 36 | 0.045 |
| 4 | 1195 | 36 | 0.035 |
| 21 | 1314 | 25 | 0.031 |
| 22 | 1317 | 27.5 | 0.022 |
| 23 | 1741 | 22.4 | 0.028 |
| 24 | 1748 | 21.6 | 0.031 |
| 25 | 1734 | 21.4 | 0.036 |
| Comparative A | 1060 | — | — |
| Comparative B | 1030 | — | — |
| Comparative C | 1057 | — | — |

^{(B)}DOC variation is ±1 micron.

TABLE 4.B

| | Compressive Stress Integral (MPa*mm) at Different Depths | | | | | | |
|---|---|---|---|---|---|---|---|
| Example | 5 μm | 8 μm | 12 μm | 16 μm | 20 μm | 25 μm | 30 μm |
| 1.2 | 5.60 | 7.47 | 8.81 | 9.43 | | | |
| 2 | 5.86 | 9.13 | 12.90 | 15.79 | 17.67 | 18.71 | 18.77 |
| 3 | 5.39 | 8.51 | 12.33 | 15.52 | 18.00 | 19.88 | 20.71 |
| 4 | 5.62 | 8.47 | 11.68 | 14.21 | 16.06 | 17.34 | 17.63 |
| 21 | 6.45 | 10.02 | 13.99 | 16.81 | 18.40 | 18.91 | — |
| 22 | 6.50 | 10.15 | 14.34 | 17.45 | 19.38 | 20.33 | — |
| 23 | 7.42 | 10.57 | 13.35 | 14.75 | 15.16 | 7.42 | — |
| 24 | 7.38 | 10.51 | 13.27 | 14.63 | 15.01 | 7.38 | — |
| 25 | 7.31 | 10.40 | 13.12 | 14.44 | 14.75 | 7.31 | — |
| Compar- | 4.62 | 6.74 | 8.83 | 10.23 | 11.17 | 11.93 | 12.36 |
| ative A | | | | | | | |
| Compar- | 4.64 | 6.94 | 9.33 | 11.05 | 12.23 | 13.21 | 13.81 |
| ative B | | | | | | | |
| Compar- | 4.94 | 7.48 | 10.21 | 12.11 | 13.21 | 13.71 | — |
| ative C | | | | | | | |

Example 21, which is approximately at or above the frangibility limit, demonstrates higher A(z) for the larger depths of 8 microns and above, and shortened overall ion exchange time. Example 22 demonstrates non-frangible profiles with larger A(z), by use of thicker glass. Thicker glass also is stiffer, which can help limit tensile stresses in high-energy-impact events.

### Examples 5-7

Examples 5-7 are glass articles whose stress profiles with high CS and increased DOC, obtained via ion exchange, heat treatment, and a second ion exchange. The glass composition was Composition I.

Table 5 provides a summary of preparation of Examples 5-7.

TABLE 5

| | Substrate | IOX | |
|---|---|---|---|
| EXAMPLE | composition | STEPS | IOX Conditions^{(A)} |
| Example 5 | I | 2-steps | STEP 1: 100 wt % K NO₃ at |
| | | DIOX + | 420° C., 24 hours + |
| | | heat | HEAT TREATMENT: 420° C., |
| | | treatment | 15 hours + |
| | | | STEP 2: 95 wt % K NO₃ + 5 K₂ CO₃ at |
| | | | 420° C., 1.25 hours |
| Example 6 | I | 2-steps | STEP 1: 100 wt % K NO₃ at |
| | | DIOX + | 430° C., 17.5 hours + |
| | | heat | HEAT TREATMENT: 425° C., |
| | | treatment | 24 hours + |
| | | | STEP 2: 95 wt % K NO₃ + 5 K₂ CO₃ at |
| | | | 420° C., 0.9 hours |
| Example 7 | I | 2-steps | STEP 1: 100 wt % K NO₃ at |
| | | DIOX + | 430° C., 18 hours + |
| | | heat | HEAT TREATMENT: 420° C., |
| | | treatment | 24 hours + |
| | | | STEP 2: 95 wt % K NO₃ + 5 K₂ CO₃ at |
| | | | 420° C., 1 hours |

^{(A)}Each of STEP 1 and STEP 2 included additive 0.5 wt % silicic acid.

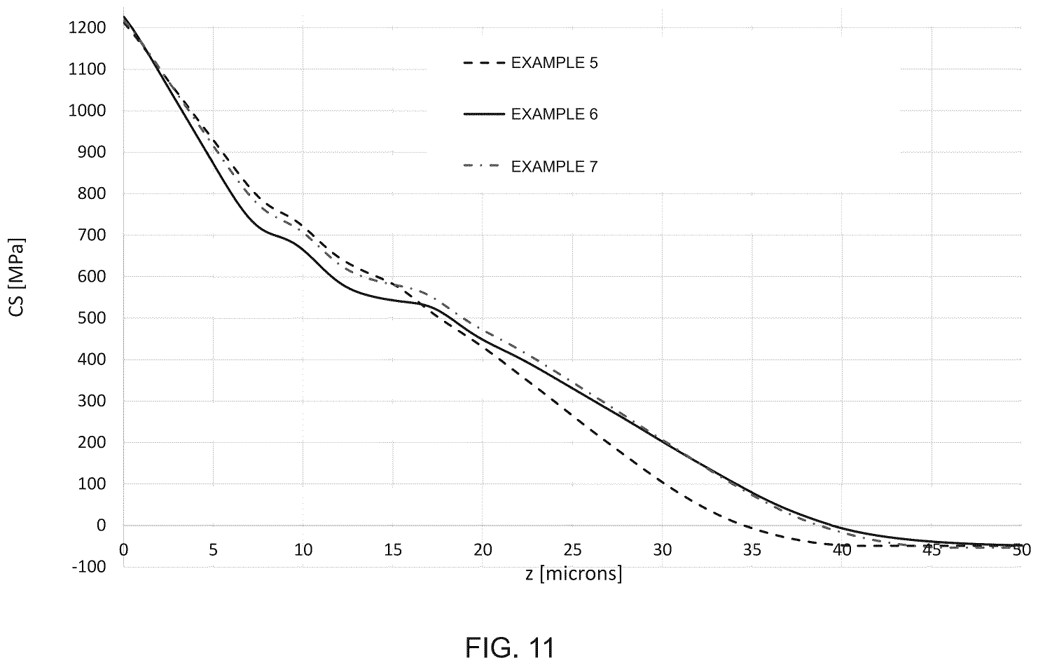

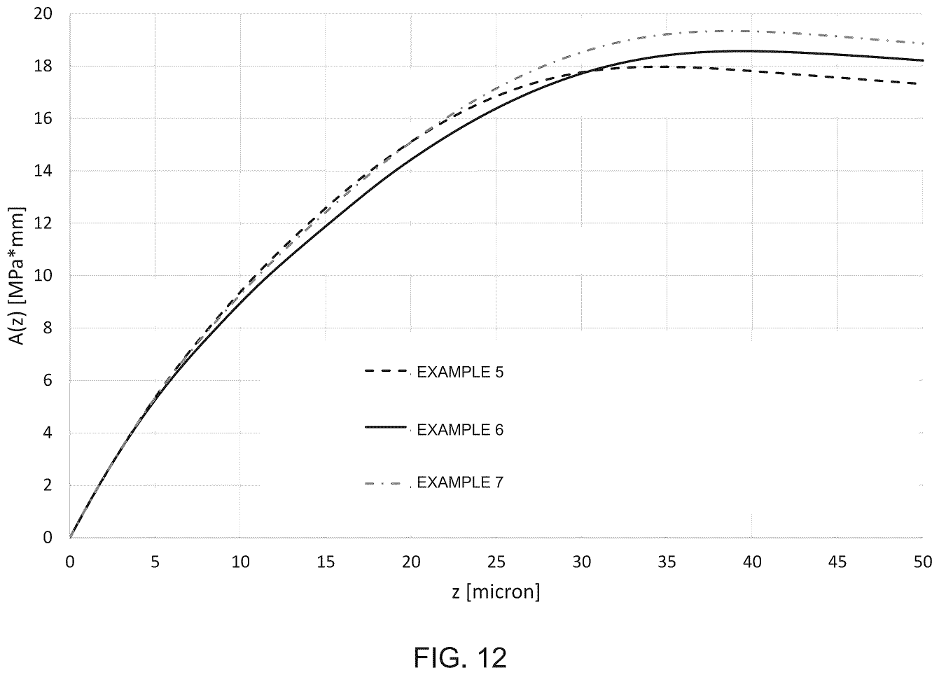

FIG. 11 shows stress profiles for Examples 5-7. FIG. 12 shows stress A(z) (compressive-stress area (CSA)) (MPa·millimeter) versus depth (micron) for the stress profiles of Examples 5-7 of FIG. 11.

Examples 5-7 targeting a combination of extended DOC, high surface CS, high compressive-stress area to target depths relevant to pre-existing flaws (up to 15 micron) and to damage-introduction flaws that may be deeper, including as deep as 30 microns. All three examples were produced by a first ion exchange step in a KNO₃ bath (with added 0.5% silicic acid), followed by a heat treatment to extend the depth of compression, and followed by another ion exchange (spike step). The spike step was produced in a bath having 95% KNO₃ and 5% K₂CO₃. The additive K₂CO₃ facilitates maximizing the surface compressive stress by helping suppress the surface concentration of Li and Na ions by effectively capturing these ions. Example 5 (dashed line) had step 1 ion exchange of 24 hours at 420° C., a heat treatment of 16 hours at 420° C., and a spike step of 1.25 hours at 420° C. Example 6 had step 1 of 17.5 hours at 430° C., heat treatment of 24 h at 425° C. to further increase the DOC, and a spike step of 0.9h at 420° C. These first two examples were strictly non-frangible. Example 7, which produced a profile on the frangibility limit, shown with the dash-dotted line, had the first ion exchange at 430° C. for 18 hours, followed by heat treatment at 420° C. for 24h, and a spike step at 420° C. for 1 h. Examples 5-7 all showed surface CS slightly above 1200 MPa. All three examples also have DOC in excess of 30 microns, falling between 34 and 40 microns. Similar to the above disclosed Examples 1.1-1.2 and 2-4, Examples 5-7 also have compressive-stress area to 5 micron greater than 4.75 MPa*mm, also greater than 5 MPa*mm and 5.2 MPa*mm. By the depth of 8 microns, Examples 5-7 all have compressive-stress area of greater 7.5 MPa*mm, generally falling between 7.5 and 8 MPa*mm. By 12 microns, Examples 5-7 have compressive-stress area of greater 10 MPa*mm. By 16 microns, Examples 5-7 have compressive-stress area of greater 12 MPa*mm. In fact, at 16 microns, Examples 5-7 each have CSA of greater than 12.4 MPa*mm, and Examples 5 and 7 of them exceeded 12.9 MPa*mm. By a depth of 20 microns, Examples 5-7 have compressive-stress area exceeding 14 MPa*mm. By the depth of 25 microns, their compressive-stress areas exceed 16 MPa*mm.

Table 6.A provides CSmax (MPa) and DOC (microns) according to the stress profiles of FIG. 11 for Examples 5-7. Table 6.B provides detailed compressive-stress area for Examples 5-7 according to FIG. 12.

TABLE 6.A

| | CSmax | DOC^{(B)} | |
|---|---|---|---|
| Example | (MPa) | (μm) | DOC/t |
| 5 | 1212 | 34.5 | 0.043 |
| 6 | 1226 | 39.4 | 0.049 |
| 7 | 1218 | 38.7 | 0.048 |

^{(B)}DOC variation is ±1 micron.

TABLE 6.B

| | Compressive Stress Integral (MPa*mm) at Different Depths | | | | | | |
|---|---|---|---|---|---|---|---|
| Example | 5 μm | 8 μm | 12 μm | 16 μm | 20 μm | 25 μm | 30 μm |
| 5 | 5.36 | 7.89 | 10.75 | 13.15 | 15.11 | 16.85 | 17.76 |
| 6 | 5.27 | 7.59 | 10.21 | 12.43 | 14.43 | 16.38 | 17.72 |
| 7 | 5.35 | 7.83 | 10.62 | 13.00 | 15.10 | 17.15 | 18.53 |

### Examples 8-10

Examples 8-10 are glass articles whose stress profiles reflect three different thermal histories (rolled, 3D-formed, and 3D-formed+annealed, respectively), obtained through a two-step ion exchange. The glass composition was Composition I.

Table 7 provides a summary of Examples 8-10 preparations.

TABLE 7

| | Substrate | Thermal | IOX | |
|---|---|---|---|---|
| EXAMPLE | composition | History | STEPS | IOX Conditions^{(A)} |
| Example 8 | I | Rolled | 2-steps | STEP 1: 100 wt % K NO₃ at |
| | | | DIOX | 430° C., 16.5 hours + |
| | | | | STEP 2: 95 wt % K NO₃ + 5 |
| | | | | K₂ CO₃ at |
| | | | | 420° C., 1.25 hours |
| Example 9 | I | 3D-formed | 2-steps | STEP 1: 100 wt % K NO₃ at |
| | | | DIOX | 430° C., 16.5 hours + |
| | | | | STEP 2: 95 wt % K NO₃ + 5 |
| | | | | K₂ CO₃ at |
| | | | | 420° C., 1.25 hours |
| Example 10 | I | 3D-formed + | 2-steps | Annealed 588° C., 2 hours |
| | | annealed | DIOX | STEP 1: 100 wt % K NO₃ at |
| | | | | 430° C., 16.5 hours + |
| | | | | STEP 2: 95 wt % K NO₃ + 5 |
| | | | | K₂ CO₃ at 420° C., 1.25 |
| | | | | hours |

^{(A)}Each of STEP 1 and STEP 2 included additive 0.5 wt % silicic acid.

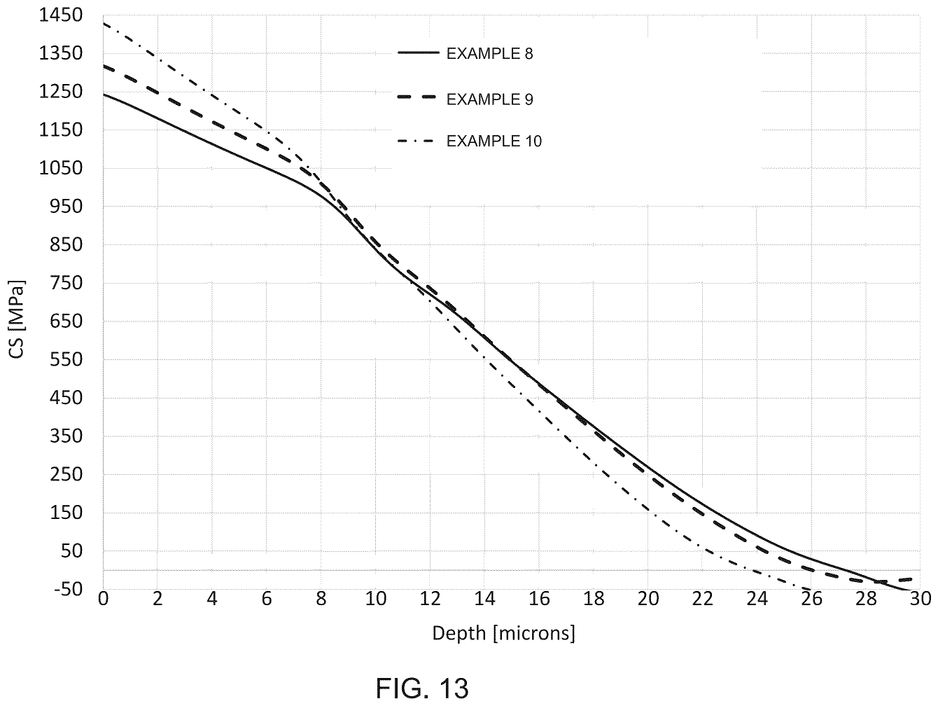

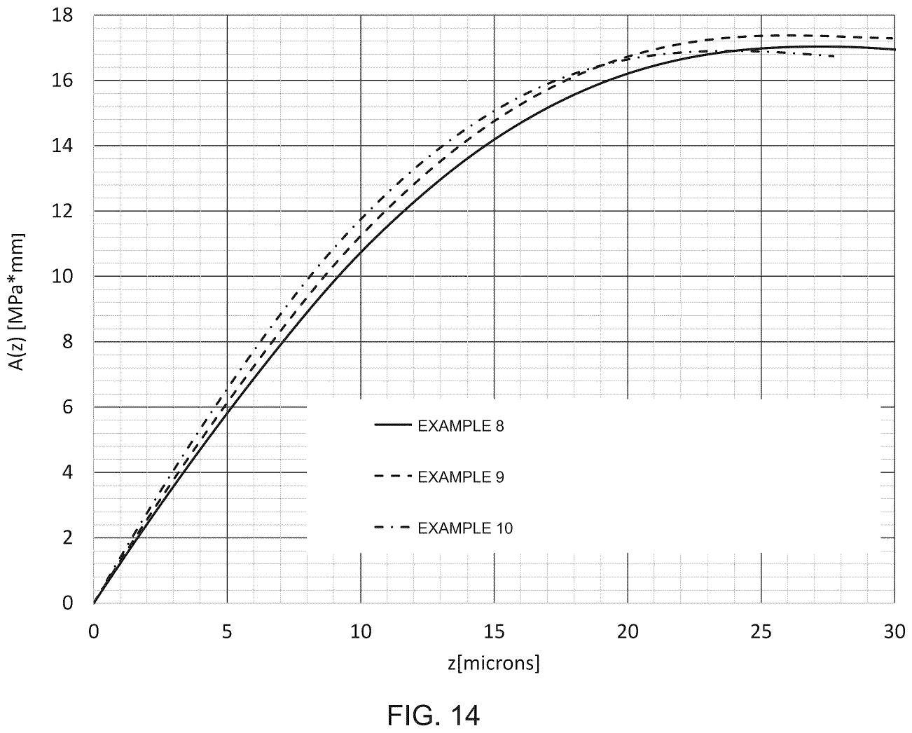

FIG. 13 shows stress profiles for Examples 8-10. FIG. 14 shows integrated stress A(z) (compressive-stress area (CSA)) (MPa·millimeter) versus depth (micron) for the stress profiles of Examples 8-10 of FIG. 13.

Table 8.A provides CSmax (MPa) and DOC (microns) according to the stress profiles of FIG. 13 for Examples 8-10. Table 8.B provides detailed compressive-stress area for Examples 8-10 according to FIG. 14.

TABLE 8.A

| | CSmax | DOC^{(B)} | |
|---|---|---|---|
| Example | (MPa) | (μm) | DOC/t |
| 8 | 1242 | 27 | 0.034 |
| 9 | 1316 | 26 | 0.032 |
| 10 | 1424 | 23.8 | 0.030 |

^{(B)}DOC variation is ±1 micron.

TABLE 8.B

| | Compressive Stress Integral (MPa*mm) at Different Depths | | | | | | |
|---|---|---|---|---|---|---|---|
| Example | 5 μm | 8 μm | 12 μm | 16 μm | 20 μm | 25 μm | 30 μm |
| 8 | 5.81 | 8.91 | 12.28 | 14.70 | 16.21 | 16.98 | 16.94 |
| 9 | 6.14 | 9.37 | 12.83 | 15.27 | 16.72 | 17.36 | 17.29 |
| 10 | 6.56 | 9.90 | 13.29 | 15.51 | 16.64 | 16.88 | — |

### Examples 11-20 and Comparative Example D

Examples 11-20 were glass articles whose stress profiles were obtained by a 2-step ion-exchange process (DIOX) whose first bath included some “poisoning” ions to facilitate ion exchange by limiting deep ion exchange and potassium exchange on the surface. By doing so, lower CS was obtained after the first step but additional CS MPa was achieved after the second step.

Comparative Example D was a glass article whose stress profile was obtained by a 2-step ion-exchange process (DIOX), where step 1 was not intentionally poisoned. A smooth IWKB technique was used to process the step 2 image of Comparative Example D, because the spacing of the first fringe pair was not larger than the spacing of the second fringe pair, for both the upper and lower spectra, unlike the inventive DIOX examples where step 1 was poisoned.

The glass compositions for Examples 11-20 and Comparative Example D were Composition I, and thickness as noted (mm) in Table 9.

Table 9 provides a summary of Examples 11-20 and Comparative Example D preparations.

TABLE 9

| | Substrate | | |
|---|---|---|---|
| | composition & | | |
| | thickness | IOX | |
| EXAMPLE | (mm) | STEPS | IOX Conditions^{(A)} |
| Comparative | I | 2-step | STEP 1: 95 wt % K NO₃ + 5 K₂ CO₃ at |
| Example D | 0.8 mm | DIOX | 420° C., 24 hours + |
| | | | STEP 2: 95 wt % K NO₃ + 5 K₂ CO₃ at |
| | | | 390° C., 4 hours |
| Example 11 | I | 2-steps | STEP 1: 0.5 wt % LiNO₃, 1 wt % NaNO₃, |
| | 0.8 mm | DIOX | 98.5 wt % K NO₃ at 420° C., |
| | | | 24 hours + |
| | | | STEP 2: 95 wt % K NO₃ + 5 K₂ CO₃ at |
| | | | 390° C., 4 hours |
| Example 12 | I | 2-steps | STEP 1: 0.3 wt % LiNO₃, 1.05 wt % |
| | 0.8 mm | DIOX | NaNO₃, 98.65 wt % K NO₃ at 420° C., |
| | | | 24 hours + |
| | | | STEP 2: 95 wt % K NO₃ + 5 K₂ CO₃ at |
| | | | 390° C., 4 hours |
| Example 13 | I | 2-steps | STEP 1: 0.3 wt % LiNO₃, 1.05 wt % |
| | 0.8 mm | DIOX | NaNO₃, 98.65 wt % K NO₃ at 420° C., |
| | | | 24 hours + |
| | | | STEP 2: 95 wt % K NO₃ + 5 K₂ CO₃ at |
| | | | 420° C., 1.42 hours |
| Example 14 | I | 2-steps | STEP 1: 0.3 wt % LiNO₃, 1.05 wt % |
| | 0.8 mm | DIOX | NaNO₃, 98.65 wt % K NO₃ at 420° C., |
| | | | 28.5 hours + |
| | | | STEP 2: 95 wt % K NO₃ + 5 K₂ CO₃ at |
| | | | 420° C., 1.83 hours |
| Example 15 | I | 2-steps | STEP 1: 0.3 wt % LiNO₃, 1.05 wt % |
| | 0.8 mm | DIOX | NaNO₃, 98.65 wt % K NO₃ at 420° C., |
| | | | 28.5 hours + |
| | | | STEP 2: 95 wt % K NO₃ + 5 K₂ CO₃ at |
| | | | 420° C., 3 hours |
| Example 16 | I | 2-steps | STEP 1: 0.2 wt % LiNO₃, 0.5 wt % NaNO₃, |
| | 0.8 mm | DIOX | 98.3 wt % K NO₃ at 420° C., |
| | | | 24 hours + |
| | | | STEP 2: 95 wt % K NO₃ + 5 K₂ CO₃ at |
| | | | 420° C., 1.83 hours |
| Example 17 | I | 2-steps | STEP 1: 0.2 wt % LiNO₃, 0.5 wt % NaNO₃, |
| | 0.8 mm | DIOX | 98.3 wt % K NO₃ at 420° C., |
| | | | 24 hours + |
| | | | STEP 2: 95 wt % K NO₃ + 5 K₂ CO₃ at |
| | | | 420° C., 3 hours |
| Example 18 | I | 2-steps | STEP 1: 0.2 wt % LiNO₃, 0.5 wt % NaNO₃, |
| | 0.8 mm | DIOX | 98.3 wt % K NO₃ at 420° C., |
| | | | 22 hours + |
| | | | STEP 2: 95 wt % K NO₃ + 5 K₂ CO₃ at |
| | | | 420° C., 1.83 hours |
| Example 19 | I | 2-steps | STEP 1: 0.2 wt % LiNO₃, 0.5 wt % NaNO₃, |
| | 1.23 mm | DIOX | 98.3 wt % K NO₃ at 420° C., |
| | | | 20 hours + |
| | | | STEP 2: 95 wt % K NO₃ + 5 K₂ CO₃ at |
| | | | 420° C., 1.83 hours |
| Example 20 | I | 2-steps | STEP 1: 0.2 wt % LiNO₃, 0.5 wt % NaNO₃, |
| | 1.23 mm | DIOX | 98.3 wt % K NO₃ at 420° C., |
| | | | 30 hours + |
| | | | STEP 2: 95 wt % K NO₃ + 5 K₂ CO₃ at |
| | | | 420° C., 1.83 hours |

^{(A)}Each of STEP 1 and STEP 2 included additive 0.5 wt % silicic acid.

Table 10.A provides CSmax (MPa) for Examples 11-20 and Comparative Example D. Table 10.B provides detailed compressive-stress area for Examples 11-20 and Comparative Example D.

TABLE 10.A

| | CSmax | DOC^{(B)} | |
|---|---|---|---|
| Example | (MPa) | (μm) | DOC/t |
| Comparative | 1301 | 27.8 | 0.035 |
| Example D | | | |
| 11 | 1534 | 23 | 0.029 |
| 12 | 1537 | 24.4 | 0.031 |
| 13 | 1535 | 24.5 | 0.031 |
| 14 | 1509 | 24.9 | 0.031 |
| 15 | 1477 | 26.8 | 0.034 |
| 16 | 1448 | 24.9 | 0.031 |
| 17 | 1416 | — | — |
| 18 | 1411 | 26.93 | 0.034 |
| 19 | 1486 | 24.9 | 0.020 |
| 20 | 1459 | 28.8 | 0.023 |

^{(B)}DOC variation is ±1 micron.

TABLE 10.B

| | Compressive Stress Integral (MPa*mm) at Different Depths | | | | | | |
|---|---|---|---|---|---|---|---|
| Example | 5 μm | 8 μm | 12 μm | 16 μm | 20 μm | 25 μm | 30 μm |
| Compar- | 6.37 | 9.86 | 13.80 | 16.74 | 18.63 | 19.68 | 19.72 |
| ative Ex- | | | | | | | |
| ample D | | | | | | | |
| 11 | 6.66 | 9.58 | 12.03 | 13.46 | 14.11 | 14.21 | — |
| 12 | 6.75 | 9.80 | 12.47 | 14.08 | 14.89 | 15.08 | — |
| 13 | 6.70 | 9.69 | 12.33 | 13.97 | 14.80 | 15.02 | — |
| 14 | 6.68 | 9.79 | 12.66 | 14.50 | 15.56 | 16.00 | — |
| 15 | 6.73 | 10.11 | 13.35 | 14.99 | 16.60 | 17.17 | — |
| 16 | 6.52 | 9.71 | 12.76 | 14.73 | 15.81 | 16.18 | — |
| 17 | 6.50 | 9.81 | 13.11 | 15.24 | 16.40 | 16.85 | — |
| 18 | 6.41 | 9.63 | 12.86 | 15.08 | 16.44 | 17.14 | — |
| 19 | 6.66 | 9.86 | 12.79 | 14.58 | 15.45 | — | — |
| 20 | 6.63 | 9.93 | 13.22 | 15.51 | 16.97 | 17.80 | 17.91 |

Comparative Example D was frangible. Comparative Example D yielded a surface CS only in the low 1300s (after step 2 which was containing carbonate; it was in the high 1200s after step 1). A significant surface CS boost following step 2 was achieved for Examples 11-20, after step 1 was intentionally poisoned.

Examples 11-13 show that with the same exact temperature and time of step 1, and same or approximately equivalent (when at higher temperature) step 2, a surface CS boost of around 200 MPa was achieved. In addition, there is some increase in A(5) as a result. To this, A(8) is unchanged A(8) and a there is a decline in A(12, 16, 20, 25) due to reduced depth of the profile when step 1 is intentionally poisoned.

Example 11 demonstrates improved surface CS. Example 12 demonstrates improved surface CS and making step 1 bath easier to manage.

Examples 13-16 demonstrate improved surface CS but with less reduction in DOC; and making step 1 bath easier to manage.

Example 17 provides improved surface CS but with less reduction in DOC; making step 1 bath easier to manage; and increasing A(z) at larger depths compared to the shorter-spike example. Example 18 speeds up DIOX compared to Example 17.

Examples 19-20 provide high surface CS combined with higher-stiffness thicker substrate, for higher fracture resistance. Example 20 also provides increased DOC above 28 micrometers.

All compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed.

It will be apparent to those skilled in the art that various modifications and variations can be made to the implementations described herein without departing from the spirit and scope of the claimed subject matter. Thus, it is intended that the specification cover the modifications and variations of the various implementations described herein provided such modification and variations come within the scope of the appended claims and their equivalents.

What is claimed is:

1. A glass article comprising:
opposing first and second surfaces defining a body of the article having a thickness (t);
a stress profile of the body comprising:
a spike region extending from the first surface to a knee located at a depth of layer (DOL);
a peak compressive stress (CSₘₐₓ) of the spike region being greater than or equal to 1150 MPa;
a tail region extending from the knee to a center of the glass article having a central tension (CT) and including a depth of compression (DOC);
a compressive stress integral at a depth of 5 micrometers that is greater than or equal to 4.75 MPa·millimeter; and
the compressive stress integral at a depth of 8 micrometers that is greater than or equal to 6.7 MPa·millimeter.

2. The glass article of claim 1, wherein the t is in a range of 0.30 millimeters to 1.5 millimeters.

3. The glass article of claim 1, wherein the DOC is greater than or equal to 0.020·t.

4. The glass article of claim 1, including one or more of the following:
the compressive stress integral at a depth of 12 micrometers is greater than or equal to 8.0 MPa·millimeter; and
the compressive stress integral at a depth of 16 micrometers is greater than or equal to 8.3 MPa·millimeter.

5. The glass article of claim 1, wherein the peak compressive stress (CSₘₐₓ) of the spike region is greater than or equal to 1200 MPa, 1250 MPa, 1300 MPa, or 1350 MPa.

6. The glass article of claim 1, wherein the compressive stress integral at a depth of 5 micrometers is greater than or equal to 5 MPa·millimeter.

7. The glass article of claim 1 comprising an alkali aluminosilicate central composition having a sodium oxide content in a range of greater than or equal to 4.0 mol % to less than or equal to 15.0 mol % Na₂O.

8. The glass article of claim 1 comprising an alkali aluminosilicate central composition having a Young's modulus that is greater than or equal to 76 GPa or greater than or equal to 80 GPa; and/or a facture toughness of greater than or equal to 0.78; and/or a Na₂O/Li₂O molar ratio in a range of greater than or equal to 1.5 to less than or equal to 2.1.

9. A glass article comprising:
opposing first and second surfaces defining a body of the article having a thickness (t) of greater than or equal to 0.70 millimeters to less than or equal to 1.3 millimeters;
a stress profile of the body comprising:
a spike region extending from the first surface to a knee located at a depth of layer (DOL);
a peak compressive stress (CSₘₐₓ) of the spike region being greater than or equal to 1000 MPa;
a tail region extending from the knee to a center of the glass article having a central tension (CT) and including a depth of compression (DOC); and
a compressive stress integral at a depth of 5 micrometers that is greater than or equal to 4.75 MPa·millimeter; and
the compressive stress integral at a depth of 8 micrometers that is greater than or equal to 7.0 MPa·millimeter.

10. The glass article of claim 9 including one or more of the following:
the compressive stress integral at a depth of 12 micrometers is greater than or equal to 10.9 MPa·millimeter;
the compressive stress integral at a depth of 16 micrometers is greater than or equal to 13.1 MPa·millimeter;
the compressive stress integral at a depth of 20 micrometers is greater than or equal to 14.1 MPa·millimeter; and
the compressive stress integral at a depth of 25 micrometers is greater than or equal to 14.9 MPa·millimeter.

11. The glass article of claim 9 comprising a 3D configuration.

12. The glass article of claim 9, wherein the peak compressive stress (CSₘₐₓ) of the spike region is greater than or equal to 1100 MPa or 1150 MPa.

13. The glass article of claim 9 comprising an alkali aluminosilicate central composition.

14. The glass article of claim 13, wherein the alkali aluminosilicate central composition has a Young's modulus that is greater than or equal to 76 GPa or greater than or equal to 80 GPa; and/or a facture toughness of greater than or equal to 0.78; and/or a Na₂O/Li₂O molar ratio in a range of greater than or equal to 1.5 to less than or equal to 2.1.

15. The glass article of claim 13, wherein the alkali aluminosilicate central composition comprises:
about 50 mol % to about 69 mol % SiO₂;
about 12.5 mol % to about 25 mol % Al₂O₃;
about 0 mol % to about 8 mol % B₂O₃;
about 11.0 mol % to about 19.0 mol % Na₂O; and
about 0.5 mol % to about 10 mol % Li₂O.

16. The glass article of claim 9 comprising the compressive stress integral at a depth of 30 micrometers of greater than or equal to 16 MPa·millimeter, or 17 MPa millimeter.

17. The glass article of claim 9, wherein the DOC is greater than or equal to 20 and optionally is less than 30 micrometers.

18. The glass article of claim 9, wherein the DOC is greater than or equal to 30 micrometers.

19. A consumer electronic product comprising:
a housing having a front surface, a back surface, and side surfaces;
electrical components provided at least partially within the housing, the electrical components including at least a controller, a memory, and a display, the display being provided at or adjacent the front surface of the housing; and
the glass article of claim 1 disposed over the display.
